(19) United States
(12) Patent Application Publication
(10) Pub. No.: US 2006/0258757 A1
(43) Pub. Date: Nov. 16, 2006

(54) Sol containing titanium dioxide, thin film formed therefrom and production process of the sol

(76) Inventors: Yasuaki Wakizaka, Toyama-shi (JP); Yasushi Kuroda, Toyama (JP)

Correspondence Address: SUGHRUE MION, PLLC, 2100 PENNSYLVANIA AVENUE, N.W., SUITE 800, WASHINGTON, DC, 20037, US

(21) Appl. No.: 10/563,218

(22) PCT Filed: Jul. 5, 2004
(86) PCT No.: PCT/JP04/09888

§ 371 Date: Jan. 3, 2006

Related U.S. Application Data
(60) Provisional application No. 60/486,217, filed on Jul. 11, 2003.
(60) Provisional application No. 60/497,307, filed on Aug. 25, 2003.

(30) Foreign Application Priority Data
Jul. 4, 2003 (JP) 2003-191881
Aug. 19, 2003 (JP) 2003-207884

(51) Int. Cl. C01G 23/047; B01F 3/12; B01J 23/00

(52) U.S. Cl. 516/90; 423/612; 502/350

(57) ABSTRACT

A sol comprising a precipitated component in an amount of less than 10 mass % based on the total solid content of the sol and comprising titanium oxide comprising a transition metal compound. When the sol is mixed with a binder which can be hardened at ambient temperature, the mixture readily forms a thin film having high photocatalytic performance on a substrate of poor heat resistance such as plastics or paper. The titanium oxide sol can readily forms titanium oxide thin film on surfaces of a variety of substrate materials such as ceramics, glass, metal, plastics, wood, or paper. Articles to which photocatalytic performance or hydrophilicity is imparted include building materials, fluorescent lamps, glass panes, machinery, vehicles, glass products, household electrical appliances, water purifying apparatuses, agricultural materials, electronic apparatus, tools, tableware, bath products, toiletry products, furniture, clothing, cloth products, fibers, leather products, paper products, sporting goods, beauty-related instruments, health improvement instruments, medical goods, futon, containers, eyeglasses, signboards, piping, wiring, brackets, sanitary materials, and automobile parts as well as environmental purification apparatuses/units.

### CROSS REFERENCE TO RELATED APPLICATIONS

This application is an application filed under 35 U.S.C. §111(a) claiming benefit pursuant to 35 U.S.C. §119(e)(1) of the filing date of the Provisional Application No. 60/486,217 filed on Jul. 4, 2003, and the Provisional Application No. 60/497,307 filed on Aug. 25, 2003, pursuant to 35 U.S.C. §111(b).

### TECHNICAL FIELD

The present invention relates to a sol containing a photocatalyst having high photoactivity, to a method for producing the sol, and to use of the sol. More particularly, the invention relates to a photocatalyst sol exhibiting a sufficient photocatalytic performance when irradiated with light from a practical light source, such as a fluorescent lamp or a light source emitting light having a wavelength of 400 nm or longer, and to use of the sol.

### BACKGROUND ART

Studies have been carried out on titanium oxide serving as a photocatalyst employed for environmental purification processes such as antibiosis, deodorization, antifouling, air cleaning, and water cleaning. Titanium oxide absorbs UV rays, to thereby excite the electrons thereof. When the resultant electrons and holes reach the surfaces of titanium oxide particles, the electrons and holes are combined with oxygen or water, thereby generating various radicals. The resultant radicals exert an oxidizing effect to thereby oxidize and decompose substances adsorbed on the surfaces of the particles. Fundamentally, a photocatalyst functions as described above.

Environmental purification processes employing such a photocatalytic function of titanium oxide, such as antibiosis, deodorization, antifouling, air cleaning, and water cleaning, have been studied.

However, obtaining an excellent photocatalytic function from titanium oxide requires UV light having a wavelength of 400 nm or less. Thus, utilization of a photocatalytic function is difficult indoors, or in an automobile, where little UV light is available.

In this connection, studies have been carried out on so-called visible-light-responsive photocatalysts, which absorb UV light having a wavelength of 400 nm or longer.

For example, Japanese Patent Application Laid-Open (kokai) Nos. 2001-72419 and 2001-205094 describe studies on visible-light absorption of titanium oxide doped with nitrogen so as to narrow a band gap. In particular, Japanese Patent Application Laid-Open (kokai) No. 2001-72419 reports that nitrogen-doped titanium oxide is produced through the reaction of a titanium trichloride solution and aqueous ammonia, and that the thus-produced titanium oxide decomposes acetaldehyde gas through exposure to visible light. Japanese Patent Application Laid-Open (kokai) No. 2001-205094 reports that titanium oxide is doped with nitrogen through sputtering, and that the thus-produced titanium oxide decomposes Methylene Blue through exposure to visible light.

Meanwhile, depositing platinum on titanium oxide has been studied in an attempt to promote charge separation between electrons and holes.

For example, Japanese Patent No. 1936966 describes that metallic platinum-deposited titanium oxide is produced through feeding a titanium oxide powder to a platinum colloid and removing the liquid from the mixture through filtration by use of, for example, an ultrafiltration membrane.

Journal of Catalysis vol. 179, p. 375, 1998 describes that metallic platinum is deposited from chloroplatinic acid on anatase titanium oxide and that an increase in alcohol decomposition performance under irradiation of visible light is confirmed.

Japanese Patent Application Laid-Open (kokai) No. 2000-262906 describes that rutile titanium oxide powder is fed to an organic platinum complex dissolved in an organic solvent.

Japanese Patent Application Laid-Open (kokai) No. 10-245439 describes that titanium oxide is immersed in a chloroplatinic acid solution for application to an FRP substrate.

Japanese Patent Application Laid-Open (kokai) No. 2002-239395 describes that chloroplatinic acid is adsorbed on titanium oxide, and that the thus-produced titanium oxide can remove NO under visible light.

Also, it has been reported that titanium hydroxide is formed from titanium tetrachloride or titanium tetraisopropoxide by use of an ammonia-containing solution, and the thus-formed titanium hydroxide is fired to produce NOₓ-containing titanium that is active with respect to visible light (Chemical Physics Letters, vol. 123, p. 126, 1986).

Japanese Patent Application Laid-Open (kokai) No. 2000-143241 discloses titanium oxide designed such that, in the case where the half-width (full width at half maximum or peak width at half height) of the peak of titanium of the titanium oxide, which is present within the bond energy range of 458 to 460 eV, is measured four times by means of X-ray photoelectron spectroscopy, and when the average of the half-widths of the peak of titanium at the first and second measurement is represented by “A” and the average of the half-widths of the peak of titanium at the third and fourth measurement is represented by “B,” the index X (i.e., B/A) is 0.97 or less.

### DISCLOSURE OF THE INVENTION

However, as photocatalyst particles produced through a technique as described in Japanese Patent Application Laid-Open (kokai) No. 2001-72419 have poor dispersibility to a medium such as water, application of a slurry containing the photocatalyst particles to a substrate is prone to impair the outer appearance of the substrate. The procedure described in Japanese Patent Application Laid-Open (kokai) No. 2001-205094 requires placement of a substrate or an article in a sputtering apparatus in order to form a photocatalyst on the surface of the substrate or the article, thereby imposing a considerable limitation on practical employment of the procedure.

However, when titanium oxide particles are mixed with a liquid, as disclosed in Japanese Patent No. 1936966, particles which tend to precipitate are formed, thereby failing to produce a sol having high dispersibility. In addition, particles produced through a technique described in Japanese Patent No. 1,936,966 are aggregated particles which do not pass through an ultrafiltration membrane having a pore size of 0.1 μm, clearly indicating that the particles have poor dispersibility.

In the method as disclosed in Journal of Catalysis vol. 179, p. 375, 1998, depositing metallic platinum via reduction requires intense light irradiation and use of explosive hydrogen gas.

In the method as disclosed in Japanese Patent Application Laid-Open (kokai) No. 2000-262906, depositing platinum on titanium oxide requires a step of evaporating the organic solvent. Therefore, various environment-related measures such as collection of evaporated organic solvent and prevention of explosion must be taken, thereby increasing complexity of the method and the facility cost.

Regarding Japanese Patent Application Laid-Open (kokai) Nos. 2000-262906 and 10-245439 and, the produced substances are in powder form and have poor dispersibility in a medium such as water. Thus, when a slurry containing the powder is applied to a substrate, the outer appearance of the substrate is prone to be impaired.

In the case of Japanese Patent Application Laid-Open (kokai) No. 2002-239395, in order to effectively absorb chloroplatinic acid on titanium oxide, the method requires cumbersome steps such as heating and feeding an incorporation accelerator (virtually a reducing agent). In addition, a photocatalyst is produced in the form of particles, which have poor dispersibility in a medium such as water. Thus, when a slurry containing the powder is applied to a substrate, the outer appearance of the substrate is prone to be impaired.

As described above, a variety of studies have been carried out so as to enhance the photocatalytic activity and produce a substrate exhibiting response to visible light. However, the attained photocatalytic performance is insufficient; a number of safety-related and environmental-related measures are required in the production steps; and very complicated steps are required.

Notably, the results of the aforementioned studies reveal problems that the produced photocatalysts are in the powder form and that, if present in a medium, the powder has poor dispersibility. Generally, dispersion of powder in a medium requires employment of untrasonication, crushing by use of a mill, addition of a dispersant to a medium, etc. In other words, imparting dispersibility to a low-dispersibility substance in subsequent steps is difficult. Furthermore, the thus-produced slurry still has insufficient dispersibility of photocatalyst particles. In addition, contamination inevitably occurs in the dispersing step.

When the substance has poor dispersibility to a medium, the outer appearance of the substrate to which a coating solution is applied is impaired, providing a detriment to practical use. In addition, when photocatalyst particles are kneaded with a substrate material (e.g., polymer, fiber, or paper), attaining uniform dispersion of the photocatalyst particles in the substrate material is difficult. Therefore, complicated pretreatment is required, and a limitation is imposed on the type of applicable substrates.

As mentioned above, in order for a photocatalyst to have increased industrial applicability, the activity of the photocatalyst powder must be enhanced, and practical means for facilitating application of the photocatalyst to a variety of substrates and articles is essential.

A first object of the present invention is to provide photocatalyst particles which exhibit high photocatalytic activity under a light source emitting light having a wavelength of 400 nm or longer and excellent photocatalytic performance under a light source emitting light having a wavelength of 400 nm or shorter, and to provide practical means for facilitating application of the photocatalyst to a variety of substrate materials and articles.

Specifically, a sol containing particles exhibiting excellent photocatalytic activity is produced in an excellent dispersion state, thereby readily forming a thin film on a surface of a substrate without impairing the outer appearance of the substrate to which the photocatalyst is applied.

The invention also aims to facilitate a step of incorporating photocatalyst particles into a substrate through a technique such as kneading.

In the case of the titanium oxide powder produced by the method as disclosed in Chemical Physics Letters, vol. 123, p. 126, 1986 or Japanese Patent Application Laid-Open (kokai) No. 2000-143241, as the powder of the titanium oxide has poor activity and is colored, application of the titanium oxide powder is limited. Therefore, the powder has the problem that the powder is not suitable for use in a coating material which requires transparency.

Many conventional photocatalysts which respond to visible light are difficult to use in practice, because they require a strong light source such as a xenon lamp in order to exhibit their catalytic performance sufficiently. Therefore, it would be greatly advantageous to practically provide a photocatalyst which exerts a sufficient effect when irradiated with light from a conventional inexpensive light source; for example, a light source usually used in a room, such as a day white fluorescent lamp.

There is also a demand for a transparent titanium oxide thin film to provide photocatalytic performance to a variety of substrates, and a titanium oxide sol having excellent dispersibility is envisaged as a raw material for the thin film. However, a slurry containing conventional nitrogen-atom-containing titanium oxide encounters a difficulty in attaining sufficient dispersibility, and the production of a transparent titanium oxide thin film that exhibits high photocatalytic response to visible light has been difficult.

The second object of the present invention is to produce a titanium oxide sol for providing a transparent thin film which exhibits high photocatalytic response to visible light. The second object of the invention also includes forming a photocatalyst thin film which exhibits a high catalytic response to visible light, through a simple technique, on a variety of substrates such as ceramics, metal, glass, plastics, paper, or wood and, further, to form a photocatalyst thin film which exhibits high photocatalytic response to visible light on a substrate with low heat resistance, such as a plastic substrate, without impairing the outer appearance of the substrate.

The present inventors have conducted extensive studies on photocatalysts in order to solve the aforementioned first problems, and have accomplished the present invention by producing a titanium oxide sol having excellent titanium oxide dispersibility and an excellent titanium oxide adsorption performance and by incorporating a transition metal compound in the form of ultrafine particles into the sol or adsorbing the compound on titanium oxide.

The present inventors have carried out extensive studies in order to solve the aforementioned second problems, and have found that a sol of brookite-containing titanium oxide containing nitrogen atoms can be produced through contact with a nitrogen-containing compound in the course of synthesis of brookite-containing titanium oxide. The inventors have also found that the produced sol is stable and provides a transparent thin film. The inventors have also found that the provided thin film serves as a photocatalyst which exhibits high photocatalytic response also to visible light.

Accordingly, the first aspect of the present invention provides the following.
(1) A sol comprising a precipitated component in an amount of less than 10 mass % based on the total solid content of the sol and comprising titanium oxide comprising a transition metal compound.
(2) The sol described in (1), wherein the sol has a transmittance of 50% or more at a wavelength of 550 nm, as measured by use of a cell having an optical path length of 2 mm, when the sol contains water as a medium and has a solid content of 1 mass %.
(3) The sol described in (1) or (2), wherein the transition metal compound does not contain particles having a particle size larger than 1 nm in an amount of 5 mass % or more.
(4) The sol described in any one of (1) to (3), which comprises the transition metal compound in an amount, as reduced to metal, of 0.01 to 1 mass % based on the total solid content.
(5) The sol described in any one of (1) to (4), wherein the transition metal compound comprises at least one selected from the group consisting of metal elements of Group 8 to 11 in the Periodic Table.
(6) The sol described in any one of (1) to (4), wherein the transition metal compound comprises at least one selected from metal elements of Group 10 in the Periodic Table.
(7) The sol described in any one of (1) to (4), wherein the transition metal compound comprises platinum as the transition metal.
(8) The sol described in any one of (5) to (7), wherein the transition metal compound comprises a chloride of the transition metal.
(9) The sol described in (8), wherein the sol comprises a solid component which exhibits peaks at 72.5 eV and 75.5 eV (within a measurement error range of ±1.0 eV), as measured through X-ray photoelectron spectroscopy.
(10) The sol described in any one of (1) to (9), which comprises a photocatalyst exhibiting photocatalytic activity under visible light.
(11) The sol described in any one of (1) to (10), wherein the solid component of the sol exhibits a diffraction peak at least at a lattice constant d (Å) of 2.90 (within a measurement error range of ±0.02 Å), as measured through powder X-ray diffraction employing Cu—Kα1 rays.
(12) The sol described in any one of (1) to (11), wherein the solid component in the sol comprises a brookite crystal titanium oxide.
(13) The sol described in (12), wherein the solid component in the sol comprises a brookite crystal titanium oxide in an amount of 10 mass % or more, as determined through Rietveld analysis.
(14) The sol described in (12), wherein the solid component in the sol comprises a brookite crystal titanium oxide in an amount of 30 mass % or more, as determined through Rietveld analysis.
(15) The sol described in any one of (1) to (14), wherein the solid component in the sol has a BET specific surface area of 20 to 400 m²/g.
(16) A method for producing a sol, characterized in that the method comprises mixing an aqueous solution of a transition metal compound with a sol comprising titanium oxide and having a precipitated component in an amount less than 10% based on the total solid content of the sol and comprising titanium oxide.
(17) A method for producing a sol, characterized in that the method comprises mixing a transition metal compound with a titanium compound and subjecting the mixture to hydrolysis.
(18) A method for producing a sol, characterized in that the method comprises hydrolyzing a titanium compound in an aqueous solution comprising a transition metal compound.
(19) The method for producing the sol as described in (17) or (18), wherein the titanium compound is titanium tetrachloride or an aqueous solution of titanium tetrachloride.
(20) The method for producing a sol as described in any one of (16) to (19), wherein the transition metal compound comprises a chloride of the transition metal.
(21) The method for producing a sol as described in any one of (17) to (20), wherein hydrolysis is performed at 50° C. to the boiling temperature.
(22) The method for producing a sol as described in (21), wherein hydrolysis is performed at 75° C. to the boiling temperature.
(23) The method for producing a sol as described in any one of (17) to (22), wherein the titanium compound is added dropwise so as to mix with the transition metal compound upon hydrolysis.
(24) The sol produced through the method for producing the sol as recited in any one of (16) to (23).
(25) A powder produced by drying the sol as recited in any one of (1) to (15), or (24).
(26) A powder produced by drying the sol as recited in any one of (1) to (15), or (24), through heating, reducing pressure, or freeze-drying, and by grinding or pulverizing the dried product.
(27) An organic polymer comprising the sol as recited in any one of (1) to (15), or (24), or the solid component of the sol.
(28) An organic polymer comprising, on a surface thereof, the sol as recited in any one of (1) to (15), or (24), or the solid component of the sol.
(29) A coating composition comprising the sol as recited in any one of (1) to (15), or (24), and a binder component.
(30) A thin film produced by applying to a substrate the sol as recited in any one of (1) to (15), or (24), or the coating composition as recited in (29), and then drying or hardening.
(31) The thin film as described in (30), which is hardened at 800° C. or lower.
(32) The thin film as described in (30), which is hardened at 150° C. or lower.
(33) The thin film as described in (30), which is hardened at 60° C. or lower.
(34) The thin film as described in any one of (30) to (33), wherein the substrate comprises a ceramic, a metal, glass, a plastic, paper, or wood.
(35) An article having on a surface thereof, or comprising a substance produced from, the sol as recited in any one of (1) to (15), or (24).
(36) The article as described in (35), which is at least one member selected from the group consisting of building materials, fluorescent lamps, glass panes, machinery, vehicles, glass products, household electrical appliances, water purifying apparatuses, agricultural materials, electronic apparatus, tools, tableware, bath products, toiletry products, furniture, clothing, cloth products, fibers, leather products, paper products, sporting goods, beauty-related instruments, health improvement instruments, medical goods, futon, containers, eyeglasses, signboards, piping, wiring, brackets, sanitary materials, and automobile parts.

The second aspect of the present invention provides the following:
[1] A brookite-containing titanium oxide which comprises nitrogen atoms in an amount of 0.001 to 10 mass %.
[2] The brookite-containing titanium oxide as described in (1], wherein the brookite-containing titanium oxide exhibits an X-ray diffraction peak attributed to brookite at a lattice constant d (Å) of 2.90 (within a measurement error range of ±0.02 Å) as measured through powder X-ray diffraction employing Cu—Kα1 rays.
[3] The brookite-containing titanium oxide as described in [2], wherein the brookite-containing titanium oxide exhibits X-ray diffraction peaks attributed to brookite at least at lattice constants d (Å) of 3.46, 2.90, 2.48, 2.14, 1.91, 1.70, 1.67, 1.50, and 1.47 (within a measurement error range of ±0.02 Å) as measured through powder X-ray diffraction employing Cu—Kα1 rays.
[4] The brookite-containing titanium oxide as described in any one of [1] to [3], wherein the brookite-containing titanium oxide exhibits an X-ray diffraction peak attributed to anatase at a lattice constant d (Å) of 2.38 (within a measurement error range of ±0.02 Å) as measured through powder X-ray diffraction employing Cu—Kα1 rays.
[5] The brookite-containing titanium oxide as described in any one of [1] to [4], wherein the brookite-containing titanium oxide exhibits a peak height ratio A/B greater than 0.5, the peak height A being measured in the vicinity of a lattice constant d (Å) of 2.90 attributed to brookite and the peak height B being measured in the vicinity of a lattice constant d (Å) of 2.38 attributed to anatase, as measured through powder X-ray diffraction employing Cu—Kα1 rays.
[6] The brookite-containing titanium oxide as described in [5], wherein the peak height ratio A/B falls within a range of 1 to 30.
[7] The brookite-containing titanium oxide as described in any one of [1] to [6], which has a mean primary particle size, as calculated from a BET specific surface area, of 0.01 to 0.1 μm.
[8] A substance having a photocatalytic function and containing the brookite-containing titanium oxide as recited in any one of [1] to [7].
[9] A sol containing the brookite-containing titanium oxide as recited in any one of [1] to [7].
[10] The sol containing a brookite-containing titanium oxide as described in [9], wherein the sol has a “precipitated solid content” in an amount of less than 30 mass % based on the total solid content of the sol, the precipitated solid content being defined as an amount of solid which is obtained by allowing the sol to stand for 240 hours in a sealed vessel at room temperature, separating, from the sol, a liquid portion corresponding to 80 vol. % of the sol as collected from the liquid surface through decantation, and drying the remaining portion.
[11] The sol containing a brookite-containing titanium oxide as described in [9] or [10], which has a solid content falling within a range of 0.01 to 10 mass %.
[12] A method for producing the sol containing a brookite-containing titanium oxide as recited in any one of [9] to [11], characterized in that the method comprises adding an aqueous solution of titanium tetrachloride to hot water at 75° C. to 100° C. comprising a nitrogen-atom-containing compound in an amount of 1 mass % or more, and hydrolyzing titanium tetrachloride within a temperature range of 75° C. to the boiling temperature of the solution.
[13] The method for producing a sol comprising a brookite-containing titanium oxide as described in [12], wherein the nitrogen-atom-containing compound is water soluble.
[14] The method for producing a sol comprising a brookite-containing titanium oxide as described in [12], wherein the nitrogen-atom-containing compound is at least one compound selected from the group consisting of ammonia, urea, hydrazine, methylamine hydrochloride, dimethylamine hydrochloride, aqueous dimethylamine solution, trimethylamine hydrochloride, aqueous trimethylamine solution, ethylamine hydrochloride, aqueous ethylamine solution, diethylamine hydrochloride, diethylamine, triethylamine hydrochloride, and triethylamine.
[15] The method for producing a sol comprising a brookite-containing titanium oxide as described in [12], wherein the nitrogen-atom-containing compound is at least one compound selected from the group consisting of ammonia, urea, and hydrazine.
[16] The method for producing a sol comprising a brookite-containing titanium oxide as described in [12], wherein the nitrogen-atom-containing compound is urea.
[17] The method for producing a sol comprising a brookite-containing titanium oxide as described in any one of [12] to [16], wherein leakage of the nitrogen-containing compound and hydrogen chloride present in the system is prevented during hydrolysis, by employing a reactor equipped with a reflux condenser. [18] The method for producing a sol comprising a brookite-containing titanium oxide as described in [12] to [16], wherein the sol has a chloride ion content adjusted to 50 to 10,000 mass ppm as reduced to chlorine atoms.
[19] The method for producing a sol comprising a brookite-containing titanium oxide as described in [18], wherein the sol has a chloride ion content adjusted to 100 to 4,000 mass ppm as reduced to chlorine atoms.
[20 ] A thin film comprising the brookite-containing titanium oxide as recited in any one of [1] to [7].
[21] A thin film comprising the substance having a photocatalytic function as recited in [8].
[22] A thin film formed from the sol as recited in any one of [9] to [11].
[23] The thin film as described in any one of [20] to [22], wherein the substrate comprises ceramics, metal, glass, plastics, paper, or wood.
[24] The thin film as described in any one of [20] to [23], which is a fired product.
[25] The thin film as described in any one of [20] to [23], which exhibits a photocatalytic performance only through drying at 80° C. or lower.
[26] An article comprising the brookite-containing titanium oxide as recited in any one of [1] to [7].
[27] The article as described in [26], which is at least one member selected from the group consisting of building materials, fluorescent lamps, window panes, machinery, vehicles, glass products, household electrical appliances, agricultural materials, electronic apparatus, tools, tableware, bath products, toiletry products, furniture, clothing, cloth products, fibers, leather products, paper products, sporting goods, beauty-related instrument, health improvement instrument, medical goods, futon, containers, eyeglasses, signboards, piping, wiring, brackets, sanitary materials, and automobile parts.
[28] An environmental purification apparatus or device employing the brookite-containing titanium oxide as recited in any one of [1] to [7].

### BRIEF DESCRIPTION OF THE DRAWINGS

FIG. 1 is a powder X-ray diffraction pattern in Example 1.

FIG. 2 is a graph showing time-dependent change in percent decomposition of Methylene Blue.

FIG. 3 is a powder X-ray diffraction pattern of brookite-containing titanium oxide which comprises nitrogen atoms.

FIG. 4 is a powder X-ray diffraction pattern of brookite-containing titanium oxide.

FIG. 5 is a powder X-ray diffraction pattern of anatase-containing titanium oxide.

### MODES OF CARRYING OUT THE INVENTION

[First Aspect of the Present Invention]

A sol of a preferred embodiment of the first aspect of the present invention preferably comprises titanium oxide of a brookite crystal form. In addition to comprising brookite titanium oxide, the sol may further comprise one or two species of anatase titanium oxide and rutile titanium oxide. The sol may also comprise an amorphous phase. In the sol, either a particle formed exclusively of one of the above phases or particles formed of a plurality of these crystalline phases may be dispersed. Preferably, at least a crystal phase clearly exhibiting a brookite crystal feature is identified.

One of the simplest and most practical methods for identifying the brookite crystal phase includes drying a sol at ambient temperature under reduced pressure or heating a sol at a temperature slightly higher than 100° C. for removing water, and subjecting the dried product to powder X-ray diffractometry.

When a sol contains titanium oxide having the brookite crystal phase, a characteristic diffraction peak is observed at a lattice constant d (Å) of approximately 2.90 Å (within a measurement error range of ±0.02 Å), as calculated from diffraction angles of Cu—Kα1 rays. However, when the sol comprises an additive which exhibits a more intense diffraction peak around the same lattice constant, the diffraction peak attributed to brookite may not be observed as a peak. In this case, it should be noted that the peak is recognized as a portion of the more intense diffraction peak.

In addition to the diffraction peak at 2.90 Å, diffraction peaks attributed to the brookite crystal phase are observed at 3.51 Å and 3.46 Å. When the sol comprises titanium oxide having the anatase crystal phase, the peak at 3.51 Å attributed to titanium oxide of the anatase crystal phase overlaps with these two diffraction peaks in the diffraction spectrum, making peak separation difficult.

In the presence of titanium oxide of the anatase crystal phase, the peak (d=3.51 Å) is difficult to identify for the reason mentioned above. In addition to the peak, a peak attributed to titanium oxide of the anatase crystal phase is observed relatively clearly at approximately 2.38 Å.

When titanium oxide of the rutile crystal phase is present, a clear peak is observed at approximately d=3.25 Å.

Through comparison of a brookite peak (2.90 Å), an anatase peak (2.38 Å), and a rutile peak (3.25 Å), presence of each crystal phase in titanium oxide can be confirmed, and a relative proportion of each crystal phase can be roughly calculated. However, as the relative peak intensities of the three crystal phases do not completely coincide with the corresponding proportions of the crystal phases contained in titanium oxide, each crystal phase content is preferably determined through the Rietveld method as described in “A Practical Guide to X-Ray Powder Analysis,” by Izumi Nakai et al. Asakura Shoten, 2002.

In the present invention, “RIETAN-2000,” a piece of software for Rietveld analysis created by Fujio IZUMI, was employed in order to confirm the relative proportion of each crystal phase. Fitting was performed through employment of a split profile function. Background shift, shift, lattice constants, FWHM (full width at half maximum) values, and relative proportion of each crystal phase were optimized until the analysis reliability factor (Rwp value, relative difference between the measured value and the calculated value) reached less than 8, granting that titanium oxide includes three crystal forms (brookite, anatase, and rutile). Through the analysis, the relative mass of each crystal phase present in the titanium oxide powder produced from the sol can be obtained.

A brookite crystal phase content in titanium oxide of 10 mass % or more is preferred, since dispersion in the titanium oxide sol and adsorption of a transition metal compound on titanium oxide are enhanced. The brookite crystal phase content is preferably 30 mass % or more, more preferably 50 mass % or more, most preferably 70 mass % or more. When the anatase crystal phase is present in an amount greater than 80 mass %, gelation of the sol tends to occur, whereas, when the rutile crystal phase is present in an amount greater more than 80 mass %, aggregation and sedimentation tend to occur.

No particular limitation is imposed on the method for quantitating a transition metal contained in the sol, and examples of the method include atomic absorption analysis and ICP emission spectroscopic analysis.

Specifically, a solid component of the sol, hydrofluoric acid, and nitric acid are placed in a sealable vessel made of Teflon (registered trade mark) resin, and the components are completely dissolved through microwave radiation or other means, to thereby form a liquid sample. The liquid sample is subjected to flame or flameless atomic absorption analysis or ICP emission spectroscopic analysis, whereby the concentration of transition metal contained in the solid component of the sol can be determined.

The context of the transition metal compound is not particularly limited and an optimum amount can be selected depending on application, but the content of the transition metal compound, as reduced to metal, is preferably 0.01 to 1 mass % based on the total solid content, more preferably 0.05 to 0.5 mass %, further preferably 0.1 to 0.3 mass %. When the content is 0.01 mass % or less, photocatalytic performance may fail to be sufficiently enhanced, whereas when transition metal is contained in an amount in excess of 1 mass %, dispersibility of a metal compound contained in or adsorbed on titanium oxide particles may be impaired. In the latter case, titanium oxide may be covered to too great an extent with a transition metal compound having low photocatalytic performance, thereby reducing the photocatalytic performance of the sol synthesized from the titanium oxide.

Although interaction between a transition metal compound and titanium oxide has not been completely elucidated, some conceivable mechanisms are as follows.

(1) When titanium oxide is irradiated with light, electrons are excited from a valence band to a conduction band, and excited electrons flow to a transition metal compound where electrons can be delocalized. This disturbs recombination of excited electrons and holes provided in the photocatalyst, thereby increasing the number of holes which can be effectively utilized. Thus, the reaction efficiency increases.

(2) A transition metal compound having a band gap narrower than that of titanium oxide is excited, thereby feeding electrons to a conduction band of titanium oxide so as to cause reduction on titanium oxide. Atomic chlorine generated on the transition metal compound causes oxidation. Thus, photocatalytic activity is expressed also under a light source emitting light having a wavelength of 400 nm or longer.

In any of the aforementioned mechanisms, high dispersibility provided by the titanium oxide sol in the present invention promotes interaction between titanium oxide and the transition metal compound. Therefore, excellent photocatalytic activity can be attained as compared with the case of conventional titanium oxide.

According to one report, the dielectric constant of brookite titanium oxide is estimated to be considerably large as compared with that of the other two types of titanium oxide (i.e., anatase and rutile titanium oxide). Thus, excellent characteristics of the brookite-containing titanium oxide employed in the present-invention may be attributable to brookite increasing polarization of titanium oxide, whereby an electrostatic interaction between titanium oxide and a surrounding substance is enhanced (an increase in the transfer of electrons or holes).

When the sol of the first aspect of the present invention is dried and a X-ray photoelectron spectrum of the dried product is measured, a new peak not attributed to a starting material may appear through interaction between a transition metal compound and titanium oxide sol. Generation of the new peak can occur when any transition metal compound is employed. For example, when the metal compound is chloroplatinic acid, new peaks are confirmed at 72.5 eV and 75.5 eV (within a measurement error range of ±1.0 eV) as peaks not attributed to a starting material.

In the first aspect of the present invention, the term “transition metal compound” refers to a compound comprising a metal belonging to Groups 3 to 11 of the Periodic Table as stipulated in “Nomenclature of Inorganic Chemistry 1989 by IUPAC.” Among such compounds, compounds comprising Group 6 to 10 metals are preferred, with those of Group 8 to 10 being more preferred and those of Group 10 being most preferred. When a metal compound other than a transition metal compound is used, the metal compound may considerably deteriorate photocatalytic performance.

The titanium oxide contained in the sol according to a preferred embodiment of the first aspect of the present invention has no internal impurity level and has high crystallinity, leading to high quantum efficiency.

The brookite-containing titanium oxide provides high dispersibility in a medium and has excellent ion adsorption performance. Such excellent characteristics cannot be found in rutile titanium oxide and anatase titanium oxide. Thus, through employment of the two characteristics (i.e., dispersibility and adsorption performance) of the brookite-containing titanium oxide, a metal compound can be effectively adsorbed on, or incorporated into, the surfaces of titanium oxide particles without performing of cumbersome steps such as heating, and adding an incorporation accelerator.

In addition, the thus-produced titanium oxide particles have an excellent characteristic that the particles exhibit high dispersibility immediately after synthesis of the sol without performing special steps with respect to the produced photocatalyst. As a result, a coating film obtained from the sol is virtually colorless and transparent. Therefore, a film of a high-performance photocatalyst which absorbs visible light having a wavelength of 400 nm or longer can be formed on a surface of a substrate or incorporated into a substrate, through a simple technique and without impairing the outer appearance of the substrate.

Next, the “precipitated component amount” and “solid content,” which are defined so as to quantitatively evaluate dispersibility and stability of the sol, will be described.

The solid content in a sol is determined by weighing the sol (100 g) in a Pyrex (registered trademark) beaker, allowing the sol to stand in a thermostat drier at 120° C. for 24 hours or longer, and measuring the mass of the remaining solid. From the mass of the solid, solid component concentration X of the sol [mass %] is calculated.

In the first aspect of the present invention, the precipitated component amount Z [g] is defined as follows. Firstly, the sol (100 g) having a solid component concentration X [mass %] is placed in a sealable vessel, and the sol is allowed to stand for 240 hours at room temperature. Then, a liquid portion corresponding to 90 vol. % of the sol as collected from the liquid surface is separated from the sol through decantation, and the remaining portion is allowed to stand for 24 hours or longer in a thermostat drier at 120° C. so as to evaporate water. The thus-obtained solid contains the precipitations as well as dispersed solid contained in a lower liquid portion which has not been removed through decantation. Thus, the precipitated component amount Z [g] is defined as the determined solid content Y [g] minus 0.1X [g] (amount of conceivably dispersed solid). In other words, the precipitated component amount Z [g] is defined by the following equation 1:
Z=Y−0.1X (equation 1)

Preferably, the precipitated component amount Z [g] does not exceed 10 mass % the total solid content X [g] (i.e., excellent dispersion state), and is preferably 0.0001 to 10 mass %, more preferably 0.001 to 5 mass %.

No particular limitation is imposed on the method for evaluating dispersibility of the sol, and the dispersibility may be evaluated as optical transmittance determined by means of a spectrometer or a spectrocolorimeter. A large transmittance value represents a state in which small particles are aggregated; i.e., excellent dispersibility.

An exemplary method for measuring transmittance by means of a spectrocolorimeter CM-3700d (product of Minoluta) will be described. A sol or slurry (concentration: 1 mass %) is placed in a cell having an optical path length of 2 mm. The light from a xenon lamp serving as a light source is diffusion-reflected by means of an integrating sphere, and the sol or slurry is irradiated with the reflected light. The transmitted light is received by means of a spectrometer for measurement. Meanwhile, light diffused in the integrating sphere is received by means of an illumination spectrometer. Each light is separated into a spectral component, and transmittance is measured at a variety of wavelengths. In the first aspect of the present invention, dispersibility of a sol or slurry is evaluated as an optical transmittance at 550 nm of the sol or slurry, when the photocatalyst particle content is 1 mass % and the optical path length (thickness) of the cell is 2 mm.

A sol according to a preferred embodiment of the first aspect of the present invention preferably has an optical transmittance of 50% or more at 550 nm, particularly preferably 60% or more. Use of a sol having such high optical transmittance is very advantageous in practical applications, since the outer appearance or the color of a substrate to which the sol is applied is not impaired.

No particular limitation is imposed on the concentration of the solid component contained in the sol, and the concentration is preferably 0.01 to 30 mass %, more preferably 0.1 to 20 mass %, yet more preferably 1 to 10 mass %. The solid component may further comprise additives other than titanium oxide and a transition metal compound.

The sol or the solid component contained in the sol can exert photocatalytic performance not only under light having a wavelength of 400 nm or shorter but also under visible light having a wavelength of 400 nm or longer.

No particular limitation is imposed on the photocatalytic performance attained by a preferred embodiment of the present invention, and examples include environmental purification functions such as antibiosis, deodorization, antifouling, air cleaning, and water cleaning. Examples of specific function will be described.

(1) When the sol or the solid component obtained from the sol is present in a system together with an organic compound such as Methylene Blue or aldehyde or an environmentally harmful substance such as NH₃, H₂S, NOₓ, or SOₓ, the concentration of the organic substance or that of the inorganic substance is reduced under light irradiation as compared with dark conditions.

(2) When the sol is applied to a substrate or an article, the contact angle between water and the substrate or the article is reduced under light irradiation as compared with dark conditions.

No particular limitation is imposed on the method for producing the titanium oxide sol employed as a preferred raw material sol in the first aspect of the present invention, and the following synthesis process is exemplified.

The titanium oxide sol serving as a raw material sol may be produced through a method described in Japanese Patent Application Laid-Open (kokai) No. 11-43327. In the synthesis of brookite-containing sol, the reaction is considered to proceed via a chloride serving as an intermediate, and controlling the chloride concentration and the temperature during synthesis are key factors. Thus, a titanium compound which generates hydrogen chloride through hydrolysis is preferably employed as a raw material. The raw material is more preferably titanium tetrachloride, yet more preferably an aqueous solution of titanium tetrachloride.

In order to maintain an optimum chloride concentration during synthesis, leakage of hydrochloric acid to the outside may be prevented though means such as application of pressure. However, the most effective method is hydrolysis performed in a reactor equipped with a reflux condenser.

Titanium oxide may be produced from a metal alkoxide as a raw material by adjusting the hydrochloric acid concentration and the water content in an organic solvent. However, the reaction medium is preferably water, from the viewpoint of ease of reaction control, cost of raw materials, and environmental load.

Hydrolysis is preferably performed at 50° C. or higher and up to the boiling temperature of an aqueous titanium tetrachloride solution. When the temperature is lower than 50° C., completion of hydrolysis requires a long period of time. The hydrolysis is performed by maintaining the reaction system at the aforementioned elevated temperature for about 10 minutes to about 12 hours. The maintenance time may be shorter under a higher hydrolysis temperature. The aqueous titanium tetrachloride solution may be hydrolyzed by heating a solution of titanium tetrachloride with water at a predetermined temperature in a reactor. Alternatively, water is heated in a reactor in advance, and titanium tetrachloride or an aqueous titanium tetrachloride solution is added to the heated water, thereby adjusting the temperature to a predetermined value. Through the above hydrolysis, titanium oxide can be produced. In order to produce titanium oxide with a high brookite content, preferably, water is heated in advance to 75° C. to the boiling point in a reactor, and titanium tetrachloride or an aqueous titanium tetrachloride solution is added to the heated water, thereby performing hydrolysis at 75° C. to the boiling temperature.

The titanium oxide particles contained in the titanium oxide sol preferably have a small particle size, since the photocatalytic action and transparency of titanium oxide thin film can be enhanced. In addition, the total surface area of titanium oxide particles in contact with the dispersion medium increases, thereby attaining effective attachment of a transition metal compound to the surfaces of titanium oxide particles. However, since titanium oxide particles of considerably small particle size may be difficult to produce, the titanium oxide particles contained in the sol preferably have a BET specific surface area of 20 to 400 m²/g, more preferably 50 to 350 m²/g, most preferably 120 to 300 m²/g.

From the viewpoint of catalytic action, the titanium oxide is preferably crystalline.

When the ionic strength of the liquid of the titanium oxide sol is high immediately after synthesis, the sol may be aggregated and form precipitations; In this case, dispersibility of the synthesized titanium oxide can be greatly enhanced through carrying out a washing step such as washing by use of an electrodialyzer for removing salt, or filtration by use of an ultrafiltration membrane.

The thus-produced high-dispersibility titanium oxide sol is brought into contact with an aqueous transition metal compound solution so as to attach the transition metal compound to the surfaces of titanium oxide particles. The most characteristic feature of the present invention is production of titanium oxide sol having high dispersibility and high photocatalytic activity in the above manner.

Complexation of titanium oxide sol and a transition metal compound will next be described.

In accordance with a preferred embodiment of the first aspect of the present invention, preferably, the titanium oxide sol which is caused to be in contact with an aqueous transition metal compound solution exhibits excellent dispersibility; i.e., has a precipitated component in an amount of less than 10 mass % of the total solid content. The precipitated component amount has the same meaning as defined above. When titanium oxide sol having high dispersibility (i.e., a precipitated component amount less than 10 mass %) is employed, a transition metal compound can be attached to the surfaces of titanium oxide particles without performing complicated steps such as heating, treatment with a reducing agent, or light irradiation.

To the surfaces of the thus-produced photocatalyst particles, a metal compound is conceived to be attached in the form of very finely divided particles having high dispersibility. The state is clearly identified by the dispersibility of the starting titanium oxide particles contained in the sol not being reduced through complexation with the metal compound. When the surfaces of the photocatalyst particles are observed under a transmission electron microscope, no metal compound attached to the surfaces of the photocatalyst particles is identified. This shows that the metal compound is present in the form of finely divided particles and exhibits high dispersibility. Therefore, the particle size of a metal compound is essentially 1 nm or less and, even if particles larger than 1 nm are present, the proportion of the particles larger than 1 nm is preferably 5 mass % or less, more preferably 3 mass % or less, particularly preferably 1 mass % or less.

No particular limitation is imposed on the transition metal compound serving as a raw material for synthesizing the sol, and examples include metal colloid, metal oxide colloid, metal hydroxide colloid, organometallic complexes, metal halides, metal salts, and metalate salts. Examples of preferred transition metal compounds include metal compounds containing a metal element of Group 8 to 11 of the Periodic Table. Examples of more preferred transition metal compounds include Group 10 metal compounds such as nickel compounds, palladium compounds, and platinum compounds. Examples of further more preferred transition metal compounds include platinum acetylacetonate, platinum bisbenzonitrile dichloride, platinum bromide anhydrate, bromoplatinic acid hydrate, sodium bromoplatinate hydrate, potassium bromoplatinate hydrate, platinum chloride anhydrate, chloroplatinic acid hydrate, sodium chloroplatinate hydrate, potassium chloroplatinate hydrate, platinum iodide anhydrate, iodoplatinic acid hydrate, sodium iodoplatinate hydrate, potassium iodoplatinate hydrate, platinum cyanide, platinum-1,3-divinyl-1,1,3,3-tetramethyldisiloxane complex, platinum iridium colloid, platinum palladium colloid, platinum ruthenium colloid, platinum rhodium colloid, platinum alumina colloid, platinum sulfide colloid, and platinum-2,4,6,8-tetramethyl-2,4,6,8-tetravinylcyclotetrasiloxane complex. Of these, platinum colloid, platinum chlorides, platinum bromides, and platinum iodides are preferred, with platinum chlorides such as hexachloroplatinic acid hydrate being particularly preferred.

The sol having high photocatalytic performance can be produced through the step of mixing the aforementioned transition metal compound with a brookite-containing titanium oxide sol exhibiting excellent adsorption to the compound and excellent dispersibility. Upon mixing the sol with the metal compound, the metal compound of the powder form may be directly mixed with a raw material sol. Alternatively, the metal compound is dissolved in a solvent or dispersed in a medium, and the solution or the dispersion may be mixed with a raw material titanium oxide sol. In order to perform uniform attachment of a metal compound to the titanium oxide sol, the metal compound dissolved in a solvent or dispersed in a medium is preferably mixed with the titanium oxide sol.

In accordance with needs, the thus-produced sol may be washed through a technique such as ultrafiltration or electrodialysis, or the pH of the sol may be modified by use of a reagent. Particularly when a powder-form photocatalyst is produced, the produced photocatalyst sol may be dried through a known technique such as heating or freeze-drying, followed by grinding or pulverizing.

The sol may also be produced by dissolving or dispersing a metal compound in water or an aqueous titanium tetrachloride solution, the water being employed during hydrolysis, an initial step of the synthesis of a raw material titanium oxide sol, and the titanium tetrachloride serving as a raw material. The metal compound serving as a raw material for synthesizing the sol may be arbitrarily selected from the above exemplified metal compounds.

By virtue of excellent dispersibility, the sol according to a preferred embodiment of the first aspect of the present invention is suitable for kneading photocatalyst particles with an organic polymer (e.g., resin) for incorporation or complex formation, or for producing particles containing an organic polymer on their surfaces.

Examples of the organic polymer employable in the first aspect of the present invention include thermoplastic resin, thermosetting resin, and naturally occurring resin. By virtue of excellent dispersibility, the photocatalyst particles can be uniformly incorporated into the organic polymer. Furthermore, since a substrate coated with the sol is virtually transparent, a photocatalytic function can be imparted to a surface of the substrate without impairing the outer appearance of the substrate.

Specific examples of the organic polymer include polyolefins (e.g., polyethylene, polypropylene, and polystyrene), polyamides (e.g., nylon 6, nylon 66, and aramid), polyesters (e.g., polyethylene terephthalate and unsaturated polyesters), polyvinyl chloride, polyvinylidene chloride, polyethylene oxide, polyethylene glycol, silicon resins, polyvinyl alcohol, vinylacetal resins, polyacetate, ABS resins, epoxy resins, vinyl acetate resins, cellulose derivatives such as cellulose and rayon, urethane resins, polyurethane, urea resins, fluorine resins, polyvinylidene fluoride, phenolic resins, celluloid, chitin, starch sheet, acrylic resins, melamine resins, and alkyd resins.

When titanium oxide thin film is formed from the titanium oxide sol, the sol produced through hydrolysis is preferably applied, without further treatment (i.e., not via dried powder), to a substrate.

The produced sol has a small primary particle size and exhibits excellent dispersibility. Therefore, when the sol is in a turbid state, the formed thin film becomes transparent.

When an optional binder is added to the sol so as to form a coating agent, and the coating agent can be applied to surfaces of a variety of structures, thereby producing photocatalytic structures. In other words, the sol may be employed as a coating agent or a coating composition.

In the first aspect of the present invention, no particular limitation is imposed on the binder material, and an organic binder or an inorganic binder may be used. Examples of the organic binder include water-soluble binders, and specific examples include polyvinyl alcohol, melamine resins, urethane resins, celluloid, chitin, starch sheet, polyacrylamide, and acrylamide. Examples of the inorganic binder include Zr compounds, Si compounds, Ti compounds, and Al compounds, and specific examples include zirconium compounds such as zirconium oxychloride, hydroxyzirconium chloride, zirconium nitrate, zirconium sulfate, zirconium acetate, ammonium zirconium carbonate, and zirconium propionate; silicon compounds such as alkoxysilanes, partial hydrolyzates of alkoxysilane by mineral acid, and silicate salts; metal alkoxides such as alkoxides of aluminum, titanium, or zirconium; and partial hydrolizates of the alkoxides formed with a mineral acid. Examples also includes complex alkoxides containing metals selected from among of aluminum, silicon, Ti, and zirconium and hydrolyzates thereof. Of these, a co-hydrolyzate of aluminum alkoxide-titanium alkoxide and a co-hydrolyzate of aluminum alkoxide-silicon alkoxide are preferred.

When a heat-resistant substrate (e.g., metal, ceramic, or glass) is employed, the titanium oxide thin film formed on the substrate may be heated. Through heating, the thin film is more tightly attached to the substrate and has an increased hardness. The heating temperature may be determined in accordance with heat resistance of the substrate. When the heating temperature is excessively elevated, hardness of the thin film and adhesion between the film and the substrate are no longer enhanced, and brookite is transformed into rutile, possibly impairing excellent characteristics. Therefore, the thin film is preferably hardened at 800° C. or lower.

When a binder which can be hardened at a temperature slightly lower than 150° C. and a substrate made of reinforced glass are employed, a titanium oxide thin film can be formed on the substrate without impairing the characteristics of reinforced glass. When a substrate made of heat-resistant resin is employed, a coating containing such a binder can be applied to the substrate and thin film is formed from the coating. When the substrate is formed of a thermoplastic resin, film is preferably formed by use of a binder which can be hardened at 60° C. or lower so as not impair the structural outer appearance of the substrate. No particular limitation is imposed on the atmosphere during hardening at an elevated temperature, and hardening may be performed in air. No particular limitation is imposed on the heating time, and the heating may be carried out for 1 to 60 minutes.

Another characteristic feature of the titanium oxide sol comprising a transition metal compound is that titanium oxide particles contained in the sol have high crystallinity, which is provided through a characteristic thermal hysteresis during synthesis.

Most conventional photocatalyst film formed from a titanium oxide precursor such as a titanium alkoxide or peroxotitanic acid exerts photocatalytic performance only after the formed film has been heated at about 500° C. so as to grow titanium oxide crystals. In contrast, the sol according to a preferred embodiment of the first aspect of the present invention has characteristic features that the sol contains titanium oxide of high crystallinity in the sol state, exhibits high photocatalytic performance, responds to visible light, and has excellent dispersibility, even though the sol is not heated.

In other words, when the sol according to a preferred embodiment of the first aspect of the present invention is mixed with a binder which can be hardened at ambient temperature, the mixture readily forms a thin film having high photocatalytic performance on a substrate of poor heat resistance such as plastics or paper. The excellent effect has not been attained by a conventional technique.

The titanium oxide sol comprising a transition metal compound can readily form a titanium oxide thin film on surfaces of a variety of substrate materials and molded products through application of the sol to the substrate. No particular limitation is imposed on the substrate, and the substrate may comprise ceramics, glass, metal, plastics, wood, or paper.

The titanium oxide thin film may also be employed as a catalyst formed on a catalyst carrier made of an alumina substrate, a zirconia substrate, etc. Before practical use, the catalyst thin film is preferably irradiated with sunlight, black light, or light from a fluorescent lamp at very high illuminance so as to effectively enhance performance of photocatalytic film. Although the reason for the enhancement has not been completely elucidated, one conceivable mechanism is that an organic substance remaining near the photocatalyst particles or an organic substance contained in air and adsorbed on the particles, the substance inhibiting photocatalytic action, is removed, thereby exposing the catalyst particles to the outside.

No particular limitation is imposed on the article to which photocatalytic performance or hydrophilicity is imparted, and examples of the article include building materials, fluorescent lamps, glass panes, machinery, vehicles, glass products, household electrical appliances, water purifying apparatuses, agricultural materials, electronic apparatus, tools, tableware, bath products, toiletry products, furniture, clothing, cloth products, fibers, leather products, paper products, sporting goods, beauty-related instruments, health improvement instruments, medical goods, futon, containers, eyeglasses, signboards, piping, wiring, brackets, sanitary materials, and automobile parts.

The first aspect of the present invention is also applicable to environmental purification apparatuses/units for effectively decomposing toxic substances which may cause so-called “sick house syndrome”; organic chlorine compounds such as PCB and dioxins present in water, air, and soil; pesticide residues in water and soil; environmental hormones; hot spring water purification; etc. In this case, no particular limitation is imposed on the mode of application. The titanium oxide containing a transition metal compound may be kneaded with resin or mixed with fiber, and the mixture is added to molding raw materials for producing articles. Alternatively, the titanium oxide may be formed on the articles.

When the first aspect of the present invention is applied to, among other applications, a fluorescent lamp, photocatalyst particles gain a considerably large amount of light (including UV rays and visible light) energy. Since fluorescent lamps are provided in almost all the houses, offices, and shops, the photocatalyst greatly contributes to decrease of concentrations of organic and inorganic substances which are harmful to the indoor environment. When applied to a water purifier, the titanium oxide according to a preferred embodiment of the first aspect of the present invention containing a transition metal compound suitably decomposes a microamount of organic impurities contained in water by virtue of very strong oxidation power.

Examples of the light source for causing the aforementioned product to effectively exhibit photocatalytic property and hydrophilicity include sunlight, a fluorescent lamp, an incandescent lamp, a mercury lamp, a xenon lamp, a halogen lamp, a mercury xenon lamp, a metal halide lamp, a light-emitting diode, a laser, and flame obtained through combustion of an organic substance.

No particular limitation is imposed on the fluorescent lamp, and examples include a fluorescent lamp equipped with UV-absorbing film, a white fluorescent lamp, a day white fluorescent lamp, a daylight fluorescent lamp, a warm white fluorescent lamp, an incandescent color fluorescent lamp, and black light.

[Second Aspect of the Present Invention]

In a preferred embodiment of the second aspect of the present invention, the brookite-containing titanium oxide refers to titanium oxide having a crystal phase attributed to brookite titanium oxide, such titanium oxide being described in, for example, “Properties and Applied Technique of Titanium Oxide” authored by Manabu Seino, p. 47 to 74, Gihodo Shuppan co., Ltd., 1991. The brookite-containing titanium oxide is not limited to a titanium oxide composed only of a brookite crystal phase, and may further contain a rutile or an anatase crystal phase. The brookite-containing titanium oxide may also comprise an amorphous portion. Any titanium oxide may be employed, so long as the titanium oxide essentially comprises a brookite crystal phase. The simplest and most generally employed method for identifying the presence of the brookite crystal phase is a powder X-ray diffraction method. When titanium oxide comprises a brookite crystal phase, X-ray diffraction peaks attributed to brookite are identified at lattice constants d (Å) of 3.46, 2.90, 2.48, 2.14, 1.91, 1.70, 1.67; 1.50, 1.47, and possibly at other values, the lattice constants being calculated from a diffraction angle measured through powder X-ray diffraction employing Cu—Kα1 rays. Each peak value may contain a measurement error of about 0.02 Å.

The peak in the vicinity of d=2.90 Å calculated through power the X-ray diffraction method is known to be a typical peak attributed to a brookite crystal phase. Similarly, the peak in the vicinity of d=2.38 Å is known to be a typical peak attributed to an anatase crystal phase, and the peak in the vicinity of d=3.25 Å is known to be a typical peak attributed to a rutile crystal phase.

Accordingly, through comparison of the peak height values, crystal phase proportions (brookite, anatase, and rutile) in titanium oxide can be roughly calculated.

Since the method for synthesizing titanium oxide according to a preferred embodiment of the second aspect of the present invention employs no high temperature treatment, the rutile content decreases. Therefore, the crystal phase of the titanium oxide is characterized by the proportion of brookite to anatase; i.e., the peak height A measured in the vicinity of d=2.90 attributed to brookite to the peak height B measured in the vicinity of d=2.38.

The titanium oxide according to a preferred embodiment of the second aspect of the present invention preferably comprises a brookite crystal phase. That is, the peak A measured in the vicinity of d=2.90 Å, a typical peak attributed to a brookite crystal phase, must be detected. The peak height ratio A/B; i.e., a ratio of brookite crystal phase to anatase crystal phase, is preferably greater than 0.5, more preferably greater than 1, further more preferably 1 to 30, still more preferably 1 to 10.

When the A/B value is smaller than 0.5, the sol may have poor stability, whereas when the A/B value is greater than 30, such titanium oxide may be difficult to synthesize, which is not preferred in practice. The brookite-containing titanium oxide of the second aspect of the present invention preferably comprises nitrogen atoms in order to enhance response to visible light. The amount of nitrogen atoms is 0.001 to 10 mass %, preferably 0.01 to 5 mass %, more preferably 0.1 to 2 mass %. When the amount is 0.001 mass % or less, response to visible light may decrease, whereas when the amount is 10 mass % or more, intrinsic characteristics of titanium oxide are impaired, thereby reducing a photocatalytic function.

No particular limitation is imposed on the method of quantification of nitrogen atoms in titanium oxide, and any of known methods may be employed. For example, a method based on Japanese Industrial Standards (JIS) H1612, “Determination of nitrogen in titanium and titanium alloy” may be employed.

Nitrogen atoms may be present inside the titanium oxide particles or on the surfaces of the titanium oxide particles. When present inside the particles, nitrogen atoms may substitute oxygen atoms, or may be present at intersticial sites. When nitrogen atoms present on the surface of the particles, nitrogen atoms may present in any form and may be present entirely or partially on the surface of the particles, but are preferably present in the form of partial coating. The partial coating may have the shape of an island, the shape of a plurality of islands, or the shape of a network.

No particular limitation is imposed on the method for introducing nitrogen atoms into titanium oxide. For example, sputtering a target formed of titanium oxide in a nitrogen-containing atmosphere is employed. Alternatively, causing titanium oxide or a thin film thereof to contact with an ammonia-containing atmosphere is employed. In these methods, no particular limitation is imposed on the temperature. In the case where a brookite crystal form is not transformed into a rutile crystal form, these operations are preferably performed at 0 to 400° C.

The titanium oxide according to a preferred embodiment of the second aspect of the present invention may be used in the form of a mixture or a bonded product with other particles, with powder, with a sintered product, or with liquid. In the second aspect of-the present invention, the term “substance exhibiting a photocatalytic function” refers to a solid (e.g., particles, powder, a sintered product, a molded product, or resin) or a liquid substance (e.g., sol, slurry, paste, or a coating composition) which comprises titanium oxide serving as a photocatalyst component.

The sol according to a preferred embodiment of the second aspect of the second aspect of the present invention will next be described.

The solid content of the sol is determined by weighing the sol (100 g) into a beaker, allowing the sol to stand in a thermostat dryer at 120° C. for 30 hours or longer, and weighing the remaining solid (by mass).

The sol according to a preferred embodiment of the second aspect of the present invention is characterized by long-term stable sol conditions. Thus, the solid content does not precipitate even when the sol has been allowed to stand for a long period of time. The feature is numerically expressed through the following measurement. A sol is allowed to stand for 240 hours in a sealed vessel at room temperature, and a liquid portion corresponding to 80 vol. % the sol as collected from the liquid surface is separated from the sol through decantation. The remaining portion is placed in a thermostat dryer at 120° C. for 30 hours or longer, thereby evaporating water, and the mass of the solid is measured. The thus-measured mass is defined as “precipitated solid content.” It is preferred that the sol has a precipitated solid content less than 30 mass % the total solid content of the sol.

When a photocatalytic film is fabricated through coating of the sol, the solid content of the sol is not particularly limited and an optimum amount may be selected depending on application, but 0.01 to 10 mass % is preferred. When the solid content is less than 0.01 mass %, a thin film exhibiting a photocatalytic function may not be formed through a coating process, whereas when the solid content is in excess of 10 mass %, stability of the sol decreases, and the thin film produced through coating of the sol may have poor transparency.

Titanium oxide particles may also be produced through subjecting the sol to filtration, washing the solid with water, and drying. When titanium oxide particles contained in the sol have a smaller particle size, photocatalytic action and transparency of the titanium oxide film are enhanced. The titanium oxide particles are preferably crystalline from the viewpoint of catalytic action. However, since titanium oxide particles having a very small particle size are difficult to produce, the primary mean particle size of the titanium oxide particles contained in the sol is desirably 0.01 to 0.1 μm, preferably 0.02 to 0.08 μm, more preferably 0.03 to 0.06 μm.

No particular limitation is imposed on the method for producing the sol, and the below-described method is exemplified.

The titanium oxide sol may be produced through a method described in Japanese Patent Application Laid-Open (kokai) No. 11-43327. In the production of brookite-containing titanium oxide sol, controlling of chloride ion concentration and of temperature during formation of titanium oxide are key factors. Thus, a titanium compound which generates hydrogen chloride through hydrolysis is preferably employed as a raw material. In other words, titanium tetrachloride is hydrolyzed under specific conditions, thereby effectively producing the sol of a preferred embodiment of the present invention. Hydrogen chloride generated during hydrolysis of titanium tetrachloride is preferably caused to remain in the sol as surely as possible by preventing leakage of hydrogen chloride from a reactor. When titanium tetrachloride is hydrolyzed with leakage of generated hydrogen chloride, the particle size of the titanium oxide particles formed in the sol may be difficult to decrease, and the formed titanium oxide may have poor crystallinity.

Leakage of hydrogen chloride generated during hydrolysis is not necessarily completely prevented, and the leakage may be suppressed to a certain extent. No particular limitation is imposed on the method of preventing leakage, so long as the leakage of hydrogen chloride can be suppressed. Although leakage of hydrogen chloride can be prevented through means such as application of pressure, the most effective and simple method is hydrolysis performed in a reactor equipped with a reflux condenser. Through the method, most of the vapor of water and the vapor of hydrogen chloride generated during hydrolysis are condensed by means of the reflux condenser, and the resultant liquid is fed back to the reactor. Thus, virtually no hydrogen chloride leaks out to the outside of the reactor.

When the titanium tetrachloride concentration of the aqueous titanium tetrachloride solution which undergoes hydrolysis is excessively low, productivity of titanium oxide may be poor, possibly lowering the efficiency of formation of thin film from the produced titanium oxide sol. When the titanium tetrachloride concentration is excessively high, reaction may proceed vigorously, and the formed titanium oxide particles may be difficult to reduce in particle size. Furthermore, the titanium oxide particles may have poor dispersibility, and are possibly not suitable for forming a transparent thin film. Thus, a production method including forming a high-concentration titanium oxide sol through hydrolysis and diluting the sol with a large amount of water so as to adjust the titanium oxide concentration to 0.05 to 10 mol/L is not preferred. In a preferred method, the titanium oxide concentration is controlled to 0.05 to 10 mol/L during formation of the sol. In order to attain the concentration range, the titanium tetrachloride concentration of the aqueous titanium tetrachloride solution is controlled to about 0.05 to 10 mol/L, which is comparable with the concentration of the formed titanium oxide. If required, addition of a small amount of water or concentration of the sol may be performed in a subsequent step so as to adjust the concentration to 0.05 to 10 mol/L.

Hydrolysis is preferably performed at 75° C. or higher and up to the boiling temperature of an aqueous titanium tetrachloride solution. When the temperature is lower than 75° C., completion of hydrolysis requires a long period of time, and brookite-crystal-form titanium oxide is difficult to form. The hydrolysis is performed by maintaining the reaction system at a predetermined temperature for about 10 minutes to about 12 hours. The maintenance time may be shorter under a higher hydrolysis temperature. The aqueous titanium tetrachloride solution may be hydrolyzed by heating a solution of titanium tetrachloride with water at a predetermined temperature in a reactor. Alternatively, water is heated in a reactor in advance, and titanium tetrachloride is added to the heated water, thereby adjusting the temperature to a predetermined value. Through the above hydrolysis, the crystal form of the formed titanium oxide generally includes brookite and anatase and/or ruitle. In order to produce titanium oxide of high brookite content, preferably, water is heated in advance to 75° C. to 100° C. in a reactor, and an aqueous titanium tetrachloride solution is added to the heated water, thereby performing hydrolysis at 75° C. to the boiling temperature of the solution.

In order to produce a brookite-containing titanium oxide sol comprising nitrogen atoms, there may be employed a method in which a nitrogen-atom-containing compound is caused to be present in the reaction system during hydrolysis of titanium tetrachloride. For example, water containing a nitrogen-atom-containing compound is heated in advance to 75° C. to 100° C. in a reactor, and an aqueous titanium tetrachloride solution is added to the heated water, thereby performing hydrolysis at 75° C. to the boiling temperature of the solution.

No particular limitation is imposed on the type of the nitrogen-atom-containing compound, so long as the compound contains a nitrogen atom, and a single species or a mixture of a plurality of compounds may be employed.

Examples of the nitrogen-atom-containing compound include ammonia, urea, hydrazine, methylamine hydrochloride, dimethylamine hydrochloride, aqueous solution of dimethylamine, trimethylamine hydrochloride, aqueous solution of trimethylamine, ethylamine hydrochloride, aqueous solution of ethylamine, diethylamine hydrochloride, diethylamine, triethylamine hydrochloride, triethylamine, aniline, acetonitrile, acrylonitrile, benzonitrile, isophthalonitrile, terephthalonitrile, nitrobenzene, pyridine, hydantoin, glycine, glycine hydrochloride, sodium glycinate hydrate, glycinamide, alanine, alaninamide hydrochloride, ammonium chloride, ammonium bromide, acrylamide, N,N-dimethylformamide, N,N-dimethylacetamide, hexamethylenediamine, aminophenol, picolinic acid, picoline, nicotinic acid, chloroaniline, and chloronitroaniline.

The nitrogen-atom-containing compound employed in the present invention is preferably water-soluble. Examples of such water-soluble compounds include ammonia, urea, hydrazine, methylamine hydrochloride, dimethylamine hydrochloride, aqueous solution of dimethylamine, trimethylamine hydrochloride, aqueous solution of trimethylamine, ethylamine hydrochloride, aqueous solution of ethylamine, diethylamine hydrochloride, diethylamine, triethylamine hydrochloride, triethylamine, aniline, acetonitrile, glycine, glycine hydrochloride, sodium glycinate hydrate, alanine, alaninamide hydrochloride, ammonium chloride, ammonium bromide, picolinic acid, and nicotinic acid.

More preferably, the nitrogen-atom-containing compound is at least one compound selected from the group consisting of ammonia, urea, hydrazine, methylamine hydrochloride, dimethylamine hydrochloride, aqueous solution of dimethylamine, trimethylamine hydrochloride, aqueous solution of trimethylamine, ethylamine hydrochloride, aqueous solution of ethylamine, diethylamine hydrochloride, diethylamine, triethylamine hydrochloride, and triethylamine.

Yet more preferably, the nitrogen-atom-containing compound is at least one compound selected from the group consisting of ammonia, urea, and hydrazine, with urea being most preferred.

The mechanism of incorporation of nitrogen atoms into titanium oxide from the nitrogen-atom-containing compound has not been completely elucidated. However, one conceivable mechanism includes thermal decomposition of the nitrogen-atom-containing compound during hydrolysis of titanium tetrachloride, thereby forming titanium oxide containing nitrogen atoms.

A method for preventing leakage of hydrogen chloride during hydrolysis including employment of a reactor equipped with a reflux condenser has already been described hereinabove. This method is also effective for preventing leakage of the nitrogen-atom-containing compound or a nitrogen-containing component formed through thermal decomposition of the compound so as to facilitate incorporation of nitrogen atoms into titanium oxide.

In titanium oxide, nitrogen atoms are conceived to replace a portion of oxygen atoms. In the case where an oxygen atom of titanium oxide is substituted by a nitrogen atom, the bond energy of the Ti—N bond as determined through X-ray photoelectron spectroscopic analysis is reported to be 396 eV (J. Appl. Phys., vol. 72, P. 3,072, 1992). The titanium oxide containing nitrogen atoms produced in the second aspect of the present invention has been identified to have a peak at 396 eV.

The chloride ion concentration of the produced sol may be arbitrarily adjusted through dechlorination or by the mediation of water; e.g., hydration or dehydration, without deviating from the scope of the invention. Chloride ions affect adhesion between thin film produced from the sol and a substrate on which the thin film has been formed, as well as transparency of the thin film. Thus, the chloride ion concentration of the sol is preferably adjusted to 50 to 10,000 ppm by mass as reduced to chlorine concentration, more preferably 100 to 4,000 ppm by mass. When the chloride ion concentration is less than 50 ppm by mass, adhesion between the substrate and the titanium oxide film formed on the substrate may be insufficient, whereas when the chloride ion concentration is in excess of 10,000 ppm by mass, the formed thin film may have poor transparency.

Although the action of the aforementioned chloride ions has not been completely elucidated, one conceivable mechanism is that electrical repulsion among titanium oxide particles in the titanium oxide sol increases, thereby enhancing dispersibility of the particles, leading to high transparency. The chloride ion concentration of the sol also affects the film strength and peel strength of the thin film formed on a substrate.

Chloride ions may be incorporated into the sol, after formation of the sol, in an amount of 50 to 10,000 ppm by mass as reduced to chlorine atoms. The thin film formed from the sol exhibits excellent photocatalytic function and excellent adhesion to a substrate.

Dechlorination may be performed by any of generally employed means. For example, electrodialysis, ion exchange resin, and electrolysis may be employed. The degree of dechlorination can be identified by the pH of the sol. For example, when the chloride ion concentration is 50 to 10,000 ppm by mass, the sol has a pH of about 5 to 0.5, and when the chloride ion concentration is 100 to 4,000 ppm by mass, the sol has a pH of about 4 to 1.

By addition of an organic solvent to the sol, titanium oxide particles can be dispersed in a mixture of water and the organic solvent.

The method for producing a titanium oxide sol may be carried out in a batch manner. Alternatively, continuous chlorination may also be performed in a manner in which titanium tetrachloride and water are continuously fed to a continuous reactor and the reaction mixture is removed through an outlet provided on the side opposite the feed inlet.

When titanium oxide thin film is formed from the titanium oxide sol, the sol produced through hydrolysis is preferably employed, without further treatment. The sol produced in a preferred embodiment of the second aspect of the present invention has a small primary particle size and exhibits excellent dispersibility. Therefore, when the sol is in a turbid state, the formed thin film becomes transparent.

When a thin film is formed from the titanium oxide sol according to a preferred embodiment of the second aspect of the present invention comprising nitrogen, a small amount (e.g., about 10 to about 10,000 ppm by mass) of a water-soluble polymer may be added to the sol so as to enhance film-formablity. Examples of preferred water-soluble polymers include poly(vinyl alcohol), methyl cellulose, ethyl cellulose, CMC, and starch.

Through application of the sol to a variety of substrate materials and molded products, a titanium oxide thin film can be readily formed on a surface of such a substrate. No particular limitation is imposed on the substrate, and the substrate may comprise ceramics, glass, metal, plastics, wood, or paper. The titanium oxide thin film may also be employed as a catalyst formed on a catalyst carrier made of an alumina substrate, a zirconia substrate, etc.

When the titanium oxide thin film is formed on a substrate such as a glass casing of an illumination apparatus such as a fluorescent lamp, or a plastic cover thereof, an organic substance such as oily fume can be decomposed without shading light, by virtue of transparency and photocatalytic action of the thin film. Furthermore, the thin film effectively prevents staining of the glass casing or the cover. When the thin film is formed on a glass member for construction applications or on a wall, staining of the glass member or the wall can also be prevented. Thus, when a wall or a window pane is made from such a member coated with the thin film, cleaning operation can be eliminated, thereby effectively lowering maintenance costs.

The photocatalytic thin film produced in a preferred embodiment of the second aspect of the present invention exhibits high response also to visible light. Therefore, the thin film exerts photocatalytic performance with respect to weak light inside the room. As used herein, the term “photocatalytic performance” refers to an anti-staining property, an anti-hazing property, super-hydrophilicity, a property of photo-decomposing an organic substance, or a similar property.

The titanium oxide sol is applied to a substrate through a method such as immersion of the substrate in a sol, spraying a sol to the substrate, or applying a sol to the substrate by use of a brush. The coating amount of the sol is appropriately 0.01 to 0.2 mm, in terms of the thickness of the coated liquid. The applied sol is dried to remove water, thereby forming a thin film. The as-formed film may be employed as, for example, a catalyst. Irradiation of the formed film with a UV ray is effective for enhancing photocatalytic performance. One possible reason for the enhancement of photocatalytic performance is that an organic substance remaining in the vicinity of a surface of the film is decomposed through photocatalytic action provided by irradiation with UV, and photocatalyst particles tend to be present on the surface of the film.

One characteristic feature of the sol according to a preferred embodiment of the second aspect of the present invention resides in that small titanium oxide particles contained in the sol have crystallinity to some extent, despite the sol being stable. Thus, the sol readily forms a photocatalytic thin film on a substrate of low heat resistance such as plastic or paper.

The thin film according to a preferred embodiment of the second aspect of the present invention has a remarkable characteristic that the film serves as a photocatalyst which exhibits high response to visible light.

When a heat-resistant substrate (e.g., metal, ceramic, or glass) is employed, the titanium oxide thin film formed on the substrate may be fired. Through firing, the thin film is more tightly attached to the substrate and attains increased hardness. The firing temperature is preferably 200° C. or higher. No particular limitation is imposed on the upper limit of the firing temperature, and the temperature may be determined in accordance with heat resistance of the substrate. When the heating temperature is elevated excessively, hardness of the thin film and adhesion between the film and the substrate are no longer enhanced; therefore, the temperature is preferably 800° C. or lower. In order to maintain the brookite crystal form, the film is preferably sintered at 700° C. or lower. No particular limitation is imposed on the firing atmosphere, and firing may be performed in air. No particular limitation is imposed on the firing time, and firing may be performed for, for example, 1 to 60 minutes.

In order to reinforce the transparent thin film and to increase adhesion of the thin film to a substrate, an appropriate adhesive may be added to the titanium oxide sol. For example, a single compound selected from the group consisting of an organic silica compound, a zirconium compound, aluminum alkoxide, and titanium alkoxide, or a mixture of two or more members, is preferred. The adhesive is added to the titanium oxide sol preferably in an amount of about 1 to about 50 mass % as reduced to metal oxide formed through hydrolysis. When the amount is less than 1 mass %, the effect of the adhesive may be poor, whereas when the amount is in excess of 50 mass %, even though bonding strength of the film to a substrate is greatly enhanced, photocatalytic performance may be reduced by the titanium oxide particles being covered with the adhesive.

The adhesive may be added to the sol just before the film formation or in advance. Either manner may be employed in accordance with the characteristics of the adhesive to be added, and does not impair the effects of the second aspect of the present invention.

The thin film containing the adhesive may optionally be fired. Irradiation of the formed film with a UV ray is effective for enhancing photocatalytic performance.

No particular limitation is imposed on the article to which photocatalytic performance or hydrophilicity is imparted by use of the brookite-containing titanium oxide of the second aspect of the present invention. Examples of the article include building materials, fluorescent lamps, window panes, machinery, vehicles, glass products, household electrical appliances, water purifiers, agricultural materials, electronic apparatus, tools, tableware, bath products, toiletry products, furniture, clothing, cloth products, fibers, leather products, paper products, sporting goods, beauty-related instruments, health improvement instruments, medical goods, futon, containers, eyeglasses, signboards, piping, wiring, brackets, sanitary materials, and automobile parts.

The present invention is also applicable to environmental purification apparatuses/units for effectively decomposing toxic substances which may cause so-called “sick house syndrome”; organic chlorine compounds such as PCB and dioxins present in water, air, and soil; pesticide residues in water and soil; environmental hormones; hot spring water purification; etc. In this case, no particular limitation is imposed on the mode of application. The brookite-containing titanium oxide may be kneaded with resin or mixed with fiber, and the mixture is added to molding raw materials for producing articles. Alternatively, the titanium oxide may be formed on the articles.

Examples of the light source for causing the aforementioned product to effectively exhibit photocatalytic property and hydrophilicity include sunlight, a fluorescent lamp, an incandescent lamp, a mercury lamp, a xenon lamp, a halogen lamp, a mercury xenon lamp, a metal halide lamp, a light-emitting diode, a laser, and flame obtained through combustion of an organic substance. No particular limitation is imposed on the fluorescent lamp, and examples include a fluorescent lamp equipped with UV-absorbing film, a white fluorescent lamp, a day white fluorescent lamp, a daylight fluorescent lamp, a warm white fluorescent lamp, an incandescent color fluorescent lamp, and black light.

Remarkable, characteristic features of a preferred embodiment of the second aspect of the present invention include that the titanium oxide thin film produced from the titanium oxide sol has a remarkably low impurity content, that very finely divided titanium oxide particles are dispersed in the film as virtually primary particles, and that the thin film has excellent photocatalytic performance by virtue of high crystallinity, and exhibits high response also to visible light.

The brookite-containing titanium oxide comprising nitrogen or a thin film thereof may be annealed under ammonia flow or sputtered. In addition to nitrogen atoms, other atoms (sulfur, transition metals, etc.) may also be introduced to the titanium oxide.

### EXAMPLES

The present invention will next be described in more detail by way of examples, which should not be construed as limiting the invention thereto.

[First Aspect of the Invention]

### Example 1

(1-1.) Synthesis of Titanium Oxide Sol

Distilled water (908 mL) was placed in a reactor equipped with a reflux condenser and was constantly heated at 95° C. An aqueous titanium tetrachloride solution (Ti content: 16.5 mass %, specific weight: 1.52, product of Sumitomo Titanium) (92 mL) was added dropwise to the reactor at about 1 mL/min while stirring at about 200 rpm was maintained. Care was taken to prevent drop of temperature of the reaction mixture. The reaction mixture was found to have a titanium tetrachloride concentration of 0.5 mol/L (4 mass % as reduced to titanium oxide). In the reactor, the reaction mixture became turbid immediately after the start of addition of titanium tetrachloride, but the temperature was maintained. After completion of addition, the temperature was elevated to 101° C. (near the boiling temperature) and maintained for 60 minutes. The thus-produced sol was washed with pure water by means of an ultrafiltration membrane (Microza ACP-1050, pore size about 6 nm, product of Asahi Kasei Corporation) until the wash liquid exhibited a conductivity of 100 μS/cm. The washed sol was concentrated so as to adjust the solid component concentration to 10 mass % upon drying at 120° C.

A portion (100 g) of the thus-produced sample was placed in a sealable vessel made of Pyrex (registered trademark) and was allowed to stand at 25° C. for 240 hours, and a liquid portion corresponding to 90 vol. % the sol as collected from the liquid surface was removed from the sol through decantation. The remaining portion (10 vol. %) was dried over 24 hours in a thermostat drier at 120° C. By subtracting the amount of titanium oxide which was conceived to be dispersed in a remaining lower liquid portion (1 g), the solid content was calculated to 0.2 g. Namely, the precipitated component amount was 2 mass % the total solid content of the sol. The transmittance of the sol, as determined at 550 nm by use of a cell having an optical path of 2 mm, was 74%.

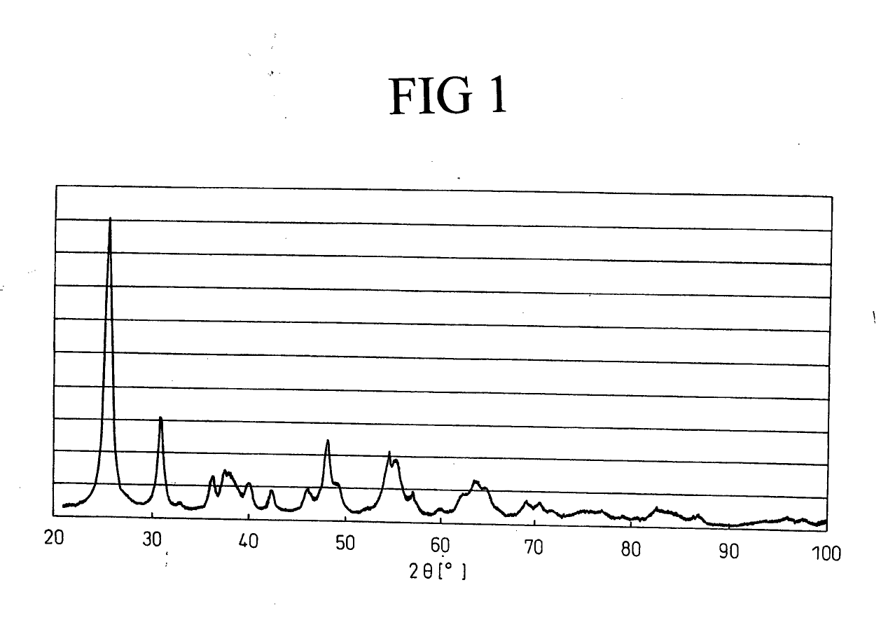

The BET specific surface area of the thus-yielded solid, as determined by use of a BET surface area meter (FlowSorb 2300, product of Shimadzu Corporation), was 150 m²/g. The solid was pulverized by use of an agate mortar, and the formed powder was subjected to powder X-ray diffractometry by use of a diffractometer Rigaku-Rint Ultima+. The measurement was performed under the following conditions: X-ray source; CuKα1 ray, output; 40 kv-40 mA, divergence slit; ½°, longitudinal divergence limiting slit; 10 mm, scatter slit ½°, and receiving slit; 0.15 mm. A diffraction pattern was obtained under FT conditions with a scan step of 0.04° and a time for counting of 25 sec. The thus-obtained x-ray diffraction pattern is shown in FIG. 1. Through Rietveld analysis of the X-ray pattern, the titanium oxide was found to contain brookite (75 mass %), anatase (20 mass %), and rutile (5 mass %).

The particle size of the titanium oxide, as determined through observation under a transmission electron microscope (JEM-200CX, product of JEOL), was found to be about 10 nm.

(1-2.) Mixing of Titanium Sol with a Transition Metal (Pt) Compound

The thus-produced titanium oxide sol (200 g) having a solid content of 10 mass % was placed in a sealable vessel made of Pyrex (registered trademark). In a Pyrex (registered trademark) beaker, hexachloroplatinic acid hexahydrate (special grade, product of Kanto Kagaku) (0.054 g, 0.1 mass % as reduced to platinum based on titanium oxide) was placed and dissolved in pure water (10 g). The thus-prepared aqueous hexachloroplatinic acid hexahydrate solution was gradually added dropwise to the titanium oxide sol under stirring at about 200 rpm. After stirring at ambient temperature for 30 minutes, the sol was washed by means of an ultrafiltration membrane until the wash liquid exhibited a conductivity of 100 μS/cm. The washed sol was concentrated so as to adjust the solid component concentration to 10 mass % upon drying at 120° C.

A portion (100 g) of the thus-produced sample was placed in a sealable vessel made of Pyrex (registered trademark) and allowed to stand at 25° C. for 240 hours, and a liquid portion corresponding to 90 vol. % of the sol, as collected from the liquid surface, was removed from the sol through decantation. The remaining portion (10 vol. %) was dried over 24 hours in a thermostat drier at 120° C. By subtracting the amount of titanium oxide which was conceived to be dispersed in a remaining lower liquid portion (1 g), the solid content was calculated to 0.25 g. Namely, the precipitated component amount was 2.5 mass % the total solid content of the sol. The transmittance of the sol, as determined at 550 nm by use of a cell having an optical path of 2 mm, was 66%.

The thus-produced solid sample was subjected to BET specific surface area measurement, powder X-ray diffractometry, and Rietveld analysis. The results are almost equivalent to those of the raw material titanium oxide sol.

The solid sample, hydrofluoric acid, and nitric acid were placed in a sealable vessel made of Teflon (registered trademark), and the components were completely dissolved by means of a microwave radiation apparatus (mls 1200 mega, product of Milestone). Through quantification of platinum in the thus-formed liquid performed by means of an ICP emission spectrometer (ICPS-7500, product of Shimadzu Corporation), the yield of platinum was found to be 101% (the first two digits being significant). The particle size of the complex titanium oxide, as determined through observation under a transmission electron microscope (JEM-200CX, product of JEOL), was found to be about 10 nm.

A photoelectron spectrum of the sol was measured by means of an X-ray photoelectron spectrometer (SSI-100X, product of SSI). In the spectrum, peaks attributed to Pt-4f orbital were identified at 72.5 eV and 75.5 eV, which are not observed in the spectrum of the raw material.

(1-3.) Methylene Blue Decolorization Test

The sol (1 mL) which had been produced in (1-2.) was placed in a Pyrex (registered trademark) vessel, and a 100 ppm (by mass) aqueous Methylene Blue solution (1 mL) and pure water (8 mL) were sequentially added to the sol. The thus-prepared blue solution was poured into three spectrometric cells having an optical path of 2 mm.

A first cell was irradiated with light (15,000 lx) from a day white fluorescent lamp (Mellow White (registered trademark), product of Toshiba Lighting & Technology Corporation). A second cell was irradiated with light (15,000 lx) from a fluorescent lamp having an UV-absorbing film (product of Toshiba Lighting & Technology Corporation). A third cell was allowed to stand under light-free conditions. The transmittance (at 660 nm) of each cell was monitored as time elapsed, and the degree of decomposition of Methylene Blue was determined on the basis of change in transmittance.

The percent decomposition of Methylene Blue (M)(%) is defined as the following equation:
M(%)=(Tₓ−T₀)/(Tₛ−T₀)×100,
wherein T₀(%) represents transmittance at an initial Methylene Blue concentration; Tₓ(%) represents transmittance X hours after the start of irradiation; and Tₛ(%) represents transmittance of the sol containing no Methylene Blue.

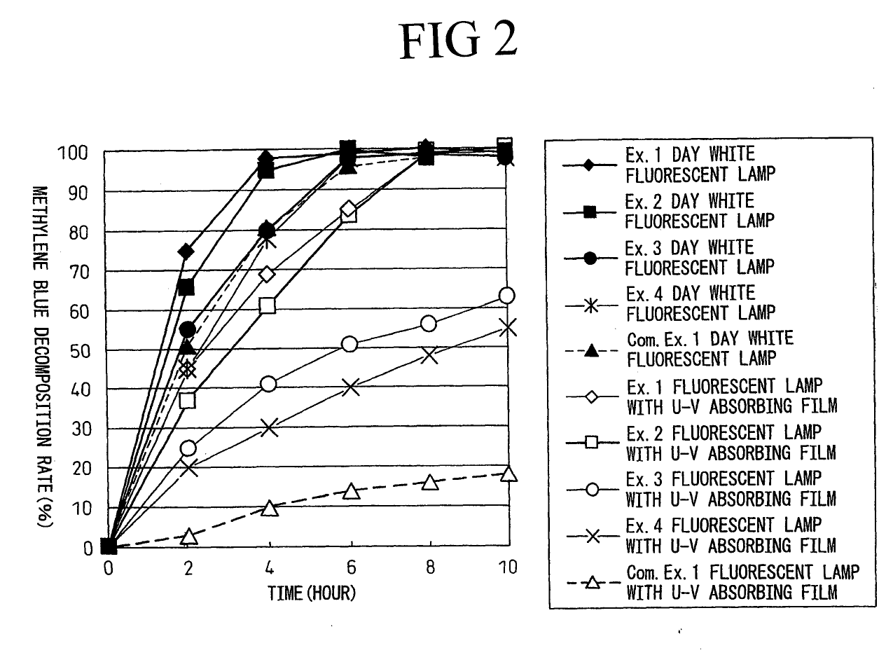

FIG. 2 shows time-dependent change in percent decomposition of Methylene Blue with respect to different light sources.

(1-4.) Film Formation by use of Hydroxyzirconium Chloride

The sol (5 mL) which had been produced in (1-2.) was placed in a Pyrex (registered trademark) vessel, and an aqueous hydroxyzirconium chloride solution (5 mL) (1.5 mass % as reduced to zirconium oxide) was added to the sol, thereby producing a coating solution (10 mL). The coating solution was poured onto a clean, square glass plate (20 cm×20 cm) until one surface was fully wetted. Subsequently, the glass plated was allowed to stand perpendicularly for about one hour until the excess liquid was removed from the plate. The coating was cured in a thermostat drier at 150° C. for 15 minutes.

(1-5.) Film Formation by use of Ammonium Zirconium Carbonate

The procedure of (1-4.) was repeated, except that ammonium zirconium carbonate was used instead of hydroxyzirconium chloride, to thereby form a film.

(1-6.) Acetaldehyde Gas Deodorization Test

Coated glass samples which had been produced in (1-4.) and (1-5.) were subjected to a deodorization test with respect to acetaldehyde. Three samples were provided in each case. Each glass sample and air containing acetaldehyde (20 ppm by volume) were confined in a Tedler (registered trademark) bag (5 L, product of GL Sciences Inc.).

A first bag was irradiated with light (6,000 lx) from a day white fluorescent lamp (Mellow White (registered trademark), product of Toshiba Lighting & Technology Corporation). A second bag was irradiated with light (6,000 lx) from a fluorescent lamp having an UV-absorbing film (product of Toshiba Lighting & Technology Corporation). A third bag was allowed to stand in the dark.

Five hours after the start of irradiation, the acetaldehyde concentration in a gas contained in each Tedler (registered trademark) bag was determined by use of a gas sensing tube (92 L, product of Gastec Corporation). Table 1 shows percent removal of gas values [%], which are the ratio of a decrease in concentration to the initial concentration (20 ppm).

(1-7.) Pencil Scratch Test and Haze Value Measurement

Samples which had been produced in (1-4.) and (1-5.) were subjected to a pencil scratch test (JIS K5400), and the haze value (the greater, the degree of haze higher) of each sample was determined by means of a haze meter (TC-H3DP, product of Tokyo Denshoku). The results are shown in Table 1.

### Example 2

(2-1.) Synthesis of Sol Containing Titanium Oxide Through Dissolving a Transition Metal Compound in Raw Materials

Hexachloroplatinic acid hexahydrate (0.108 g, 0.1 mass % as reduced to platinum based on titanium oxide) was dissolved in an aqueous titanium tetrachloride solution (92 mL), to thereby prepare an aqueous titanium tetrachloride solution containing platinum. The procedure of (1-1.) was repeated, except that the thus-prepared solution was employed instead of an aqueous titanium tetrachloride solution, to thereby synthesize a sol. Thus, in a single step, a sol containing a transition metal compound and titanium oxide was obtained.

The precipitated component amount was found to be 3 mass % of the total solid content of the sol. The transmittance of the sol, as determined at 550 nm by use of a cell having an optical path of 2 mm, was 68%.

The BET specific surface area of the thus-yielded solid was 145 m²/g. The solid was pulverized by use of an agate mortar, and the formed powder was subjected to powder X-ray diffractometry. Through Rietveld analysis of the thus-obtained X-ray pattern, the product was found to contain brookite (75 mass %), anatase (15 mass %), and rutile (10 mass %).

Through quantification of platinum, the yield of platinum was found to be 96% (the first digit being significant). A photoelectron spectrum of the sol was measured, and peaks were identified at 72.5 eV and 75.5 eV, which are not observed in the spectrum of the raw material.

(2-2.) Methylene Blue Decolorization Test

The procedure of (1-3.) was repeated, except that the sol produced in (2-1.) was employed instead of the sol produced in (1-2.), to thereby perform a Methylene blue decolorization test. The results are shown in FIG. 2.

(2-3.) Film Fformation by Use of Hydroxyzirconium Chloride

The procedure of (1-4.) was repeated, except that the sol produced in (2-1.) was employed instead of the sol produced in (1-2.), to thereby form a film.

(2-4.) Film Formation by Use of Ammonium Zirconium Carbonate

The procedure of (1-5.) was repeated, except that the sol produced in (2-1.) was employed instead of the sol produced in (1-2.), to thereby form a film.

(2-5.) Acetaldehyde Gas Deodorization Test

The procedure of (1-6.) was repeated, except that the samples produced in (2-3.) and (2-4.) were employed instead of the samples produced in (1-4.) and (1-5.), to thereby perform a deodorization test. The results are shown in Table 1.

(2-6.) Pencil Scratch Test and Haze Value Measurement

The procedure of (1-7.) was repeated, except-that the samples produced in (2-3.) and (2-4.) were employed instead of the samples produced in (1-4.) and (1-5.), to thereby perform a pencil scratch test and measure haze values. The results are shown in Table 1.

### Example 3

(3-1.) Synthesis of Titanium Oxide Sol

The procedure of (1-1.) was repeated, to thereby synthesize a titanium oxide sol containing brookite.

(3-2.) Mixing of Titanium Oxide Sol and a Transition Metal (Fe) Compound

The procedure of (1-2.) was repeated, except that iron chloride (special grade, product of Kanto Kagaku) (0.097 g, 0.1 mass % as reduced to iron based on titanium oxide) was employed instead of hexachloroplatinic acid hexahydrate (special grade, product of Kanto Kagaku) (0.054 g), to thereby mix a titanium oxide sol with a metal compound.

The precipitated component amount was found to be 3 mass % the total solid content of the sol. The transmittance of the sol, as determined at 550 nm by use of a cell having an optical path of 2 mm, was 69%.

The thus-produced solid sample was subjected to BET specific surface area measurement, powder X-ray diffractometry, and Rietveld analysis. The results are almost equivalent to those of the raw material titanium oxide sol. Through quantification of iron element, the yield of iron was found to be 90% (the first digit being significant).

(3-3.) Methylene Blue Decolorization Test

The procedure of (1-3.) was repeated, except that the sol produced in (3-2.) was employed instead of the sol produced in (1-2.), to thereby perform a Methylene blue decolorization test. The results are shown in FIG. 2.

(3-4.) Film Formation by Use of Hydroxyzirconium Chloride

The procedure of (1-4.) was repeated, except-that the sol produced in (3-2.) was employed instead of the sol produced in (1-2.), to thereby form a film.

(3-5.) Film Formation by Use of Ammonium Zirconium Carbonate

The procedure of (1-5.) was repeated, except that the sol produced in (3-2.) was employed instead of the sol produced in (1-2.), to thereby form a film.

(3-6.) Acetaldehyde Gas Deodorization Test

The procedure of (1-6.) was repeated, except that the samples produced in (3-4.) and (3-5.) were employed instead of the samples produced in (1-4.) and (1-5.), to thereby perform a deodorization test. The results are shown in Table 1.

(3-7.) Pencil Scratch Test and Haze Value Measurement

The procedure of (1-6.) was repeated, except that the samples produced in (3-4.) and (3-5.) were employed instead of the samples produced in (1-4.) and (1-5.), to thereby perform a pencil scratch test and measure haze values. The results are shown in Table 1.

### Example 4

(4-1.) Synthesis of Titanium Oxide Sol

The procedure of (1-1.) was repeated, to thereby produce a titanium oxide sol containing brookite.

(4-2.) Mixing of Titanium Oxide Sol and a Transition Metal (Au) Compound

The procedure of (1-2.) was repeated, except that tetrachloroauric acid tetrahydrate (special grade, product of Kanto Kagaku) (0.042 g, 0.1 mass % as reduced to gold based on titanium oxide) was employed instead of hexachloroplatinic acid hexahydrate (special grade, product of Kanto Kagaku) (0.054 g), to thereby mix a titanium oxide sol and a transition metal compound.

The precipitated component amount was found to be 2 mass % the total solid content of the sol. The transmittance of the sol, as determined at 550 nm by use of a cell having an optical path of 2 mm, was 67%.

The thus-produced solid sample was subjected to BET specific surface area measurement, powder X-ray diffractometry, and Rietveld analysis. The results are almost equivalent to those of the raw material titanium oxide sol. Through quantification of elemental gold, the yield of gold was found to be 91% (the first digit being significant).

(4-3.) Methylene Blue Decolorization Test

The procedure of (1-3.) was repeated, except that the sol produced in (4-2.) was employed instead of the sol produced in (1-2.), to thereby perform a Methylene blue decolorization test. The results are shown in FIG. 2.

(4-4.) Film Formation by Use of Hydroxyzirconium Chloride

The procedure of (1-4.) was repeated, except that the sol produced in (4-2.) was employed instead of the sol produced in (1-2.), to thereby form a film.

(4-5.) Film Formation by Use of Ammonium Zirconium Carbonate

The procedure of (1-5.) was repeated, except that the sol produced in (4-2.) was employed instead of the sol produced in (1-2.), to thereby form a film.

(4-6.) Acetaldehyde Gas Deodorization Test

The procedure of (1-6.) was repeated, except that the samples produced in (4-4.) and (4-5.) were employed instead of the samples produced in (1-4.) and (1-5.), to thereby perform a deodorization test. The results are shown in Table 1.

(4-7.) Pencil Scratch Test and Haze Value Measurement

The procedure of (1-7.) was repeated, except that the samples produced in (4-4.) and (4-5.) were employed instead of the samples produced in (1-4.) and (1-5.), to thereby perform a pencil scratch test and measure haze values. The results are shown in Table 1.

### Comparative Example 1

(5-1.) Brookite-Containing Titanium Oxide Sol Containing No Transition Metal Compound

The brookite-containing titanium oxide sol containing a solid component in an amount of 10 mass % and synthesized in (1-1.) was employed as a sample of Comparative Example 1.

(5-2.) Methylene Blue Decolorization Test

The procedure of (1-3.) was repeated, except that the sol produced in (5-1.) was employed instead of the sol produced in (1-2.), to thereby perform a Methylene blue decolorization test. The results are shown in FIG. 2.

(5-3.) Film Formation by Use of Hydroxyzirconium Chloride

The procedure of (1-4.) was repeated, except that the sol produced in (5-1.) was employed instead of the sol produced in (1-2.), to thereby form a film.

(5-4.) Film Formation by Use of Ammonium Zirconium Carbonate

The procedure of (1-5.) was repeated, except that the sol produced in (5-1.) was employed instead of the sol produced in (1-2.), to thereby form a film.

(5-5.) Acetaldehyde Gas Deodorization Test

The procedure of (1-6.) was repeated, except that the glass samples produced in (5-3.) and (5-4.) were employed instead of the glass samples produced in (1-4.) and (1-5.), to thereby perform a deodorization test. The results are shown in Table 1.

(5-6.) Pencil Scratch Test and Haze Value Measurement

The procedure of (1-7.) was repeated, except that the glass samples produced in (5-3.) and (5-4.) were employed instead of the glass samples produced in (1-4.) and (1-5.), to thereby perform a pencil scratch test and measure haze values. The results are shown in Table 1.

### Comparative Example 2

(6-1.) Slurry Containing a Transition Metal (Pt) Compound and Anatase-Containing Titanium Oxide

Hexachloroplatinic acid hexahydrate (0.135 g, 0.1 mass % as reduced to platinum based on titanium oxide) was added to pure water (500 mL), and the mixture was thoroughly stirred. Titanium oxide photocatalyst particles ST-01 (50 g, product of Ishihara Sangyo Kaisha, Ltd.) and a 50% aqueous hypophosphorous acid (7.2 mL) were sequentially added to the mixture, followed by heating for one hour at 90° C. The product was washed by means of an ultrafiltration membrane until the wash liquid exhibited a conductivity of 100 μS/cm. The washed product was concentrated so as to adjust the solid component concentration to 10 mass %, to thereby produce a slurry.

The transmittance of the slurry, as determined at 550 nm by use of a cell having an optical path of 2 mm, was 30%. However, since progress of sedimentation was visually observed in the cell during measurement, the complete suspension was conceived to exhibit a transmittance lower than 30%. The precipitated component amount was found to be 86 mass % the total solid content of the slurry.

The BET specific surface area of the thus-yielded solid sample was 300 m²/g. Through Rietveld analysis of the powder X-ray diffraction pattern, the titanium oxide contained in the slurry was found to have an anatase content of 100 mass %. Through quantification of platinum element, the yield of platinum was found to be 89% (the first digit being significant).

(6-2.) Methylene Blue Decolorization Test

No significant change in transmittance of the slurry of (6-1) was not be measured, since sedimentation of photocatalyst particles with adsorption of Methyelen Blue occurred as time elapsed, and bluish aggregates were deposited at the bottom of the cell.

(6-3.) Film Formation by Use of Hydroxyzirconium Chloride

The procedure of (1-4.) was repeated, except that the slurry produced in (6-1.) was employed instead of the sol produced in (1-2.), to thereby form a film.

(6-4.) Film Formation by Use of Ammonium Zirconium Carbonate

The procedure of (1-5.) was repeated, except that the slurry produced in (6-1.) was employed instead of the sol produced in (1-2.), to thereby form a film.

(6-5.) Acetaldehyde Gas Deodorization Test

The procedure of (1-6.) was repeated, except that the glass samples produced in (6-3.) and (6-4.) were employed instead of the glass samples produced in (1-4.) and (1-5.), to thereby perform a deodorization test. The results are shown in Table 1.

(6-6.) Pencil Scratch Test and Haze Value Measurement

The procedure of (1-6.) was repeated, except that the glass samples produced in (6-3.) and (6-4.) were employed instead of the glass samples produced in (1-4.) and (1-5.), to thereby perform a pencil scratch test and measure haze values. The results are shown in Table 1.

### Comparative Example 3

(7-1.) Slurry Containing a Transition Metal (Pt) Compound and Anatase-Containing Titanium Oxide

Hexachloroplatinic acid hexahydrate (0.135 g, 0.1 mass % as reduced to platinum based on titanium oxide) was added to pure water (500 mL), and the mixture was thoroughly stirred. Titanium oxide photocatalyst particles ST-01 (50 g, product of Ishihara Sangyo Kaisha, Ltd.) were added to the mixture, followed by heating for one hour at 90° C. The product was washed by means of an ultrafiltration membrane until the wash liquid exhibited a conductivity of 100 μS/cm. The washed product was concentrated so as to adjust the solid component concentration to 10 mass %, to thereby produce a slurry.

The transmittance of the slurry, as determined at 550 nm by use of a cell having an optical path of 2 mm, was 30%. However, for the same reason as described in (6-1), the complete suspension was conceived to exhibit a transmittance lower than 30%. The precipitated component amount was 83 mass % the total solid content of the slurry.

The BET specific surface area of the thus-yielded solid sample was 300 m²/g. Through Rietveld analysis of the powder X-ray diffraction pattern, the titanium oxide contained in the slurry was found to have an anatase content of 100 mass %. Through quantification of platinum element, the yield of platinum was found to be 55% (the first digit being significant).

(7-2.) Methylene Blue Decolorization Test

No significant change in transmittance of the slurry of (7-2) was measured, since the slurry assumed the same sedimentation conditions as those of (6-2.).

(7-3.) Film Formation by Use of Hydroxyzirconium Chloride

The procedure of (1-4.) was repeated, except that the slurry produced in (7-1.) was employed instead of the sol produced in (1-2.), to thereby form a film.

(7-4.) Film Formation by Use of Ammonium Zirconium Carbonate

The procedure of (1-5.) was repeated, except that the slurry produced in (7-1.) was employed instead of the sol produced in (1-2.), to thereby form a film.

(7-5.) Acetaldehyde Gas Deodorization Test

The procedure of (1-6.) was repeated, except that the glass samples produced in (7-3.) and (7-4.) were employed instead of the glass samples produced in (1-4.) and (1-5.), to thereby perform a deodorization test. The results are shown in Table 1.

(7-6.) Pencil Scratch Test and Haze Value Measurement

The procedure of (1-7.) was repeated, except that the glass samples produced in (7-3.) and (7-4.) were employed instead of the glass samples produced in (1-4.) and (1-5.), to thereby perform a pencil scratch test and measure haze values. The results are shown in Table 1.

### Comparative Example 4

(8-1.) Slurry Containing a Transition Metal (Fe) Compound and Anatase-Containing Titanium Oxide

The procedure of (7-1.) was repeated, except that iron chloride (special grade, product of Kanto Kagaku) (0.242 g, 0.1 mass % as reduced to iron based on titanium oxide) was employed instead of hexachloroplatinic acid hexahydrate (0.135 g), to thereby produce a slurry.

The transmittance of the slurry, as determined at 550 nm by use of a cell having an optical path of 2 mm, was 31%. However, for the same reason as described in (6-1.), the complete suspension was conceived to exhibit a transmittance lower than 31%. The precipitated component amount was 84 mass % the total solid content of the slurry.

The BET specific surface area of the thus-yielded slurry was 300 m²/g. Through Rietveld analysis of the powder X-ray diffraction pattern, the titanium oxide contained in the slurry was found to have an anatase content of 100 mass %. Through quantification of iron elemental, the yield of iron was found to be 60% (the first digit being significant).

(8-2.) Methylene Blue Decolorization Test

No significant change in transmittance of the slurry was measured, since the slurry assumed the same sedimentation conditions as those of (6-2.).

(8-3.) Film Formation by Use of Hydroxyzirconium Chloride

The procedure of (1-4.) was repeated, except that the slurry produced in (8-1.) was employed instead of the sol produced in (1-2.), to thereby form a film.

(8-4.) Film Formation by Use of Ammonium Zirconium Carbonate

The procedure of (1-5.) was repeated, except that the slurry produced in (8-1.) was employed instead of the sol produced in (1-2.), to thereby form a film.

(8-5.) Acetaldehyde Gas Deodorization Test

The procedure of (1-6.) was repeated, except that the glass samples produced in (8-3.) and (8-4.) were employed instead of the glass samples produced in (1-4.) and (1-5.), to thereby perform a deodorization test. The results are shown in Table 1.

(8-6.) Pencil Scratch Test and Haze Value Measurement

The procedure of (1-7.) was repeated, except that the glass samples produced in (8-3.) and (8-4.) were employed instead of the glass samples produced in (1-4.) and (1-5.), to thereby perform a pencil scratch test and measure haze values. The results are shown in Table 1.

### Comparative Example 5

(9-1.) Slurry Containing a Transition Metal Compound and Anatase-Containing Titanium Oxide

The procedure of (7-1.) was repeated, except that tetrachloroauric acid tetrahydrate (0.105 g, 0.1 mass % as reduced to gold based on titanium oxide) was employed instead of hexachloroplatinic acid hexahydrate (0.135 g), to thereby produce a slurry.

The transmittance of the slurry, as determined at 550 nm by use of a cell having an optical path of 2 mm, was 30%. However, for the same reason as described in (6-1.), the complete suspension was conceived to exhibit a transmittance lower than 30%. The precipitated component amount was found to be 83 mass % the total solid content of the slurry.

The BET specific surface area of the thus-yielded slurry was 300 m²/g. Through Rietveld analysis of the powder x-ray diffraction pattern, the titanium oxide contained in slurry was found to have an anatase content of 100 mass %. Through quantification of gold element, the yield of gold was found to be 54% (the first digit being significant).

(9-2.) Methylene Blue Decolorization Test

No significant change in transmittance of the slurry was measured, since the slurry assumed the same sedimentation conditions as those of (6-2.).

(9-3.) Film Formation by Use of Hydroxyzirconium Chloride

The procedure of (1-4.) was repeated, except that the slurry produced in (9-1.) was employed instead of the sol produced in (1-2.), to thereby form a film.

(9-4.) Film Formation by Use of Ammonium Zirconium Carbonate The procedure of (1-5.) was repeated, except that the slurry produced in (9-1.) was employed instead of the sol produced in (1-2.), to thereby form a film.

(9-5.) Acetaldehyde Gas Deodorization Test

The procedure of (1-6.) was repeated, except that the glass samples produced in (9-3.) and (9-4.) were employed instead of the glass samples produced in (1-4.) and (1-5.), to thereby perform a deodorization test. The results are shown in Table 1.

(9-6.) Pencil Scratch Test and Haze Value Measurement

The procedure of (1-7.) was repeated, except that the glass samples produced in (9-3.) and (9-4.) were employed instead of the glass samples produced in (1-4.) and (1-5.), to thereby perform a pencil scratch test and measure haze values. The results are shown in Table 1.

TABLE 1

| | | Percent removal of gas | | | | |
|---|---|---|---|---|---|---|
| | | Day white | With UV- | | Pencil | |
| | | fluorescent | absorbing | In the | hard- | Haze |
| | | lamp | film | dark | ness | value |
| Film | Ex. 1 | 85 | 65 | 15 | 4H | 1 |
| forming | Ex. 2 | 80 | 60 | 15 | 4H | 0.8 |
| method | Ex. 3 | 75 | 50 | 10 | 4H | 1 |
| 1 | Ex. 4 | 75 | 45 | 10 | 4H | 1 |
| | Comp. Ex. 1 | 75 | 20 | 10 | 4H | 0.9 |
| | Comp. Ex. 2 | 80 | 45 | 15 | <6B | 15 |
| | Comp. Ex. 3 | 75 | 35 | 15 | <6B | 16 |
| | Comp. Ex. 4 | 55 | 20 | 15 | <6B | 15 |
| | Comp. Ex. 5 | 50 | 15 | 10 | <6B | 14 |
| Film | Ex. 1 | 90 | 70 | 15 | 3H | 0.8 |
| forming | Ex. 2 | 85 | 60 | 10 | 2H | 0.7 |
| method | Ex. 3 | 75 | 50 | 10 | 3H | 0.9 |
| 2 | Ex. 4 | 80 | 55 | 10 | 2H | 0.9 |
| | Comp. Ex. 1 | 75 | 25 | 10 | 2H | 0.7 |
| | Comp. Ex. 2 | 85 | 50 | 15 | <6B | 12 |
| | Comp. Ex. 3 | 70 | 40 | 15 | <6B | 13 |
| | Comp. Ex. 4 | 50 | 20 | 15 | <6B | 14 |
| | Comp. Ex. 5 | 50 | 15 | 15 | <6B | 12 |

[Second Aspect of the Present Invention]

### Example 11

(Synthesis of Brookite-Containing Titanium Oxide Sol Containing Nitrogen and Solid Content Analysis)

Ion exchanged water (700 mL) and urea (11.3 g) were placed in a reactor, and the mixture was heated to 95° C. with stirring and maintained at this temperature. An aqueous titanium tetrachloride solution (Ti concentration: 15 mass %, product of Sumitomo Titanium) (120 g) was added dropwise to the mixture over 60 minutes. After completion of addition, the mixture was heated to 101° C. and maintained at this temperature for 60 minutes under stirring. The thus-produced white suspension was subjected to dialysis by use of an electric dialyzer, to thereby adjust the pH of the suspension to 4.0. The suspension was concentrated by means of an ultra filtration membrane, to thereby produce a white slurry. A portion of the white slurry was placed in a glass scalable vessel, and allowed to stand for 240 hours at room temperature. Subsequently, a liquid portion corresponding to 80 vol. % the slurry was separated from the slurry through decantation, and the remaining portion was dried in a thermostat drier at 120° C. for 30 hours. The mass of the thus-obtained powder was measured, to thereby derive the “precipitated solid content.”

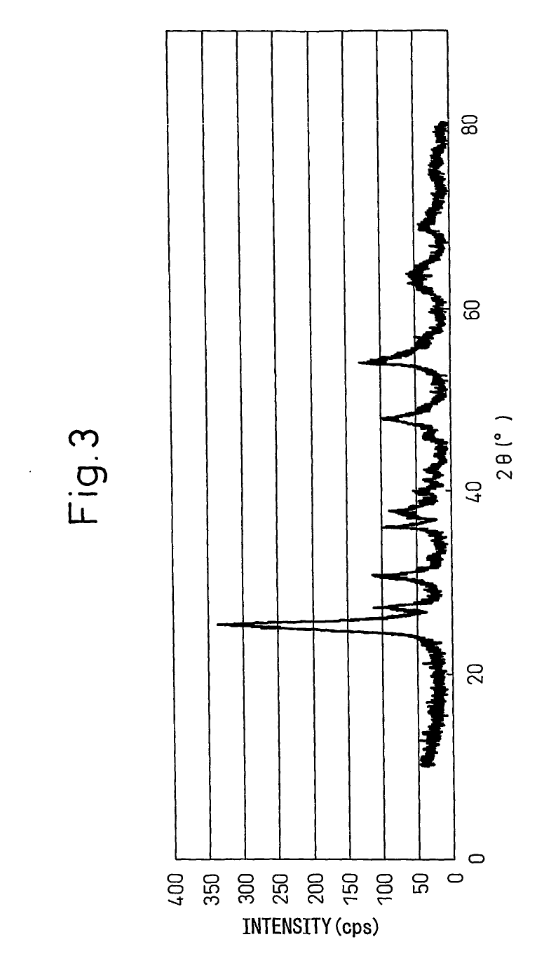

Another portion of the white slurry was sampled, and the solid content of the slurry was determined through a dry constant weight method. The total solid content was found to be 4.2 mass %, and the precipitated solid content was found to be 22 mass % the total solid content. The yielded solid was yellowish. The solid was pulverized by use of an agate mortar, and the formed powder was subjected to powder X-ray diffractometry by use of a diffractometer Rigaku-Rint Ultima⁺. The measurement was performed under the following conditions: X-ray source; CuKα1 ray, output; 40 kV-20 mA, slits; DS 1°-SS 1°-RS 0.3 mm, scan speed; 2°/min, and measurement range; 10° to 80°. The thus-obtained diffraction chart is shown in FIG. 3. The peak height ratio A/B was found to be 1.5, wherein the peak height A was measured at d=2.90 (2θ=30.8) and the peak height B was measured at d=2.38 (2θ=37.7), revealing that the titanium oxide contained the brookite crystal form.

The nitrogen content of the titanium oxide, as determined through a method based on Japanese Industrial Standards (JIS) H1612, was 0.47 mass %. X-ray photoelectron spectroscopic analysis of the powder of the titanium oxide confirmed a peak at 396 eV, revealing that a Ti—N bond was present in the titanium oxide.

On the supposition that the titanium oxide particle is considered a true sphere, the mean primary particle size of the titanium oxide particles, as determined by use of a BET specific surface area value in accordance with the following equation (1), was calculated to be 0.04 μm.
D1=6/ρS (1)
(ρ: True specific gravity of particles, S: BET specific surface area)
(Evaluation of Photocatalytic Activity)

Titanium oxide powder (0.1 g) was spread on a glass Petri dish (diameter: 90 mm), and the dish was placed in a Tedler (registered trademark) bag (5 L, product of GL Sciences Inc.). Air (about 5 L) containing acetaldehyde (20 ppm by volume) was fed into the bag, and the bag was sealed, to thereby prepare a sample. Three samples were tested. A first bag was allowed to stand in the dark. A second bag was irradiated with light (6,000 lx) from a day white fluorescent lamp (Mellow White (registered trademark), 20 W, product of Toshiba Lighting & Technology Corporation). A third bag was irradiated with light (6,000 lx) from a fluorescent lamp having a UV-absorbing film (20 W, product of Toshiba Lighting & Technology Corporation). Two hours after the start of irradiation, the acetaldehyde concentration in a gas contained in each Tedler (registered trademark) bag was determined by use of a gas sensing tube (No. 92L, product of Gastec Corporation). The acetaldehyde concentration values of the first sample (in the dark), the second sample (under a day white fluorescent lamp), and the third sample (under a fluorescent lamp having a UV-absorbing film) were found to be 15 ppm by vol., 3 ppm by vol., and 6 ppm by vol., respectively.

### Example 12

(Fabrication of Thin Film)

An aqueous zirconium hydroxychloride solution (5 mass % as reduced to ZrO₂) (4 g) and ethyl alcohol (10 g) were mixed with the sol (20 g) which had been produced in Example 11, to thereby prepare a coating liquid. The coating liquid (4 mL) was poured on a glass plate (20 cm×20 cm) and spread over the plate by use of a glass rod. Subsequently, the glass plated was allowed to stand vertically for 10 minutes so as to remove excess coating liquid from the plate. The coating was maintained in a thermostat drier at 150° C. for 10 minutes. The thus-formed thin film was colorless and transparent and exhibited no peeling when scratched with a 3H pencil.

(Evaluation of Photocatalytic Activity)

The thin film-coated glass plate produced in the aforementioned step was placed in a Tedler (registered trademark) bag (5 L, product of GL Sciences Inc.). Air (about 5 L) containing acetaldehyde (20 ppm by volume) was fed into the bag, and the bag was sealed, to thereby prepare a sample. Three samples were tested under the same irradiation conditions as employed in Example 11. Four hours after the start of irradiation, the acetaldehyde concentration was determined in a similar manner. The acetaldehyde concentration values of the first sample (in the dark), the second sample (under a day white fluorescent lamp), and the third sample (under a fluorescent lamp having a UV-absorbing film) were found to be 19 ppm by vol., 5 ppm by vol., and 8 ppm by vol., respectively.

### Example 13

(Preparation of Binder Solution)

To a 200-mL flask equipped with a reflux condenser, ion-exchanged water (90 mL), methanol (30 mL), acetylacetone (5 g), and acetic acid (5 g) were placed, and the mixture was heated to 70° C. under stirring and maintained at the temperature. Aluminum triisopropoxide (12 g) was added to the heated mixture, and the resultant mixture was refluxed for two hours, followed by allowing to stand for cooling under stirring, to thereby prepare a binder solution.

(Fabrication of Thin Film)

Ion-exchanged water (50 g) and the binder solution (30 g) prepared in the above step were mixed with the sol (20 g) which had been produced in Example 11, to thereby prepare a coating liquid. The coating liquid (4 mL) was poured on a glass plate (20 cm×20 cm) and spread over the plate by use of a glass rod. Subsequently, the glass plated was allowed to stand vertically for 10 minutes so as to remove excess coating liquid from the plate. The coating was dried for curing at room temperature (within a range of 15° C. to 25° C.) for 24 hours. The thus-formed thin film assumed colorless and transparent and exhibited no peeling when scratched with a 3H pencil.

(Evaluation of Photocatalytic Activity)

The obtained thin film was evaluated in terms of photocatalytic activity in a manner similar to that employed in Example 12. The acetaldehyde concentration values of the first sample (in the dark), the second sample (under a day white fluorescent lamp), and the third sample (under a fluorescent lamp having a UV-absorbing film) were found to be 19 ppm by vol., 8 ppm by vol., and 11 ppm by vol., respectively.

### Comparative Example 11

(Synthesis of Brookite-Containing Titanium Oxide Sol Containing no Nitrogen and Solid Content Analysis)

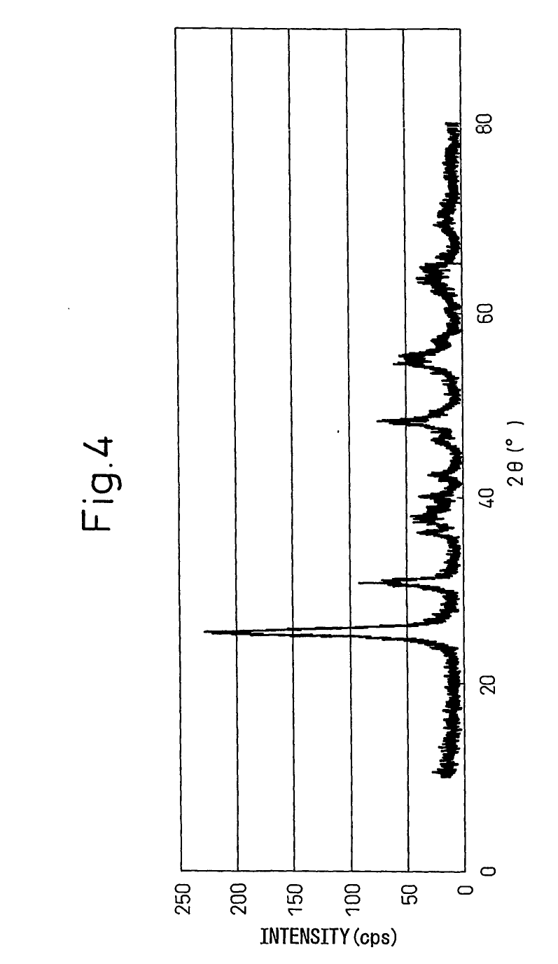

The procedure of Example 11 was repeated, except that no urea was added to the reactor, to thereby prepare a titanium oxide sol. In a manner similar to that of Example 11, the total solid content of the sol and the precipitated solid content were determined to be 4.4 mass % and 21 mass % the total solid content, respectively. The yielded solid was white. The solid was pulverized by use of an agate mortar, and the formed powder was subjected to powder X-ray diffractometry under the same conditions as described in relation to Example 11. The thus-obtained diffraction chart is shown in FIG. 4. The peak height ratio (A/B) as defined in Example 11 was found to be 3.0, revealing that the titanium oxide contained the brookite crystal form. The nitrogen content of the titanium oxide, as determined through a method based on Japanese Industrial Standards (JIS) H1612, was less than 0.01 mass % (detection limit). The mean primary particle size of the titanium oxide particles, as determined in accordance with equation (1), was 0.04 μm. From these results, the thus-produced titanium oxide and titanium oxide sol were confirmed to be virtually similar to the titanium oxide and titanium oxide sol produced in Example 11, except for the presence of nitrogen in titanium oxide.

(Evaluation of Photocatalytic Activity)

The photocatalytic activity was evaluated in a manner similar to that employed in Example 11. The acetaldehyde concentration values of the first sample (in the dark), the second sample (under a day white fluorescent lamp), and the third sample (under a fluorescent lamp having a UV-absorbing film) were found to be 15 ppm by vol., 0 ppm by vol., and 13 ppm by vol., respectively. Although the photocatalytic activity measured in Comparative Example 11 under a day white fluorescent lamp was superior to that measured in Example 11, response to visible light was clearly inferior.

### Comparative Example 12

(Synthesis of Titanium Oxide Sol Containing Nitrogen and Solid Content Analysis)

Ion exchanged water (100 mL) and urea (11.3 g) were placed in a reactor, and, at room temperature, an aqueous titanium tetrachloride solution (Ti concentration: 15 mass %, product of Sumitomo Titanium) (120 g) was added dropwise to the mixture. Under stirring, 28% aqueous ammonia was added to the resultant mixture so as to adjust the pH to 8, whereby white titanium oxide was formed. Subsequently, the mixture was heated to 101° C. and maintained for 60 minutes under stirring. The thus-produced white suspension was washed and concentrated by means of an ultra filtration membrane, to thereby produce a white slurry. A portion of the white slurry was placed in a sealable glass vessel, and allowed to stand at room temperature. Twenty-four hours thereafter, the slurry was completely separated into a transparent supernatant and white precipitates. In other words, the sol was not stable. The phase-separated system was continuously left to stand for 240 hours, and the “precipitated solid content” as described in relation to Example 11 was determined.

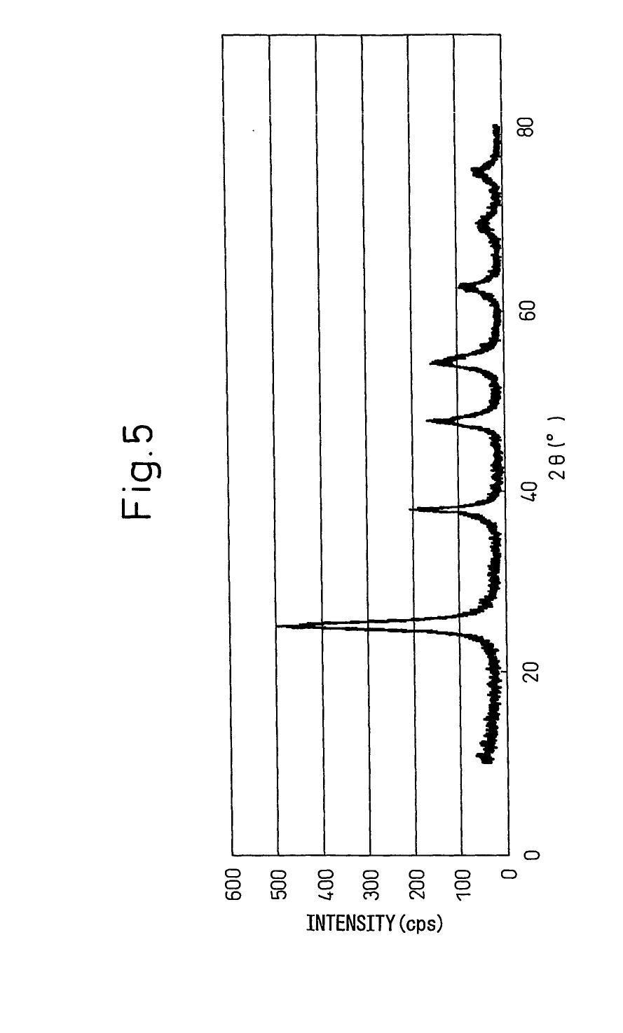

The mixture was sufficiently stirred. Under stirring, another portion of the white slurry was sampled, and the solid content of the slurry was determined through a dry constant weight method. The total solid content was found to be 4.8 mass %, and the precipitated solid content was found to be 96 mass % the total solid content. The yielded solid was yellowish. The solid was pulverized by use of an agate mortar, and the formed powder was subjected to powder x-ray diffractometry under the same conditions as described in relation to Example 11. The thus-obtained diffraction chart is shown in FIG. 5. The peak height ratio (A/B) as defined in Example 11 was found to be less than 0.1, revealing that the titanium oxide powder clearly contained anatase-form crystals and no brookite-form crystals.

The nitrogen content of the titanium oxide, as determined through a method based on Japanese Industrial Standards (JIS) H16 12 , was 0.33 mass %. X-ray photoelectron spectroscopic analysis of the powder of the titanium oxide confirmed a peak at 396 eV, revealing that a Ti—N bond was present in the titanium oxide.

The mean primary particle size of the titanium oxide particles, as determined in accordance with equation (1), was 0.12 μm.

(Evaluation of Photocatalytic Activity)

The photocatalytic activity was evaluated in a manner similar to that employed in Example 11. The acetaldehyde concentration values of the first sample (in the dark), the second sample (under a day white fluorescent lamp), and the third sample (under a fluorescent lamp having a UV-absorbing film) were found to be 17 ppm by vol., 13 ppm by vol., and 16 ppm by vol., respectively. The photocatalytic activity measured in Comparative Example 12 was clearly inferior to that measured in Example 11.

### Comparative Example 13

(Fabrication of Thin Film)

In a manner similar to Example 12, the sol produced in Comparative Example 12 was applied on a glass plate, to thereby form a thin film. The formed thin film clearly assumed turbid appearance. When scratched with a 3H pencil, the film was peeled off from the glass plate.

### INDUSTRIAL APPLICABILIITY

The sol according to the first aspect of the present invention comprising titanium oxide and a transition metal compound exhibits high photocatalytic performance under a light source emitting light having a wavelength of 400 nm or longer. The titanium oxide particles have no internal impurity level and have high crystallinity, thereby serving as photocatalyst particles of high quantum efficiency. The sol in which the particles are well dispersed in a medium can be produced through a simple technique. By use of the thus-produced sol containing high-dispersiblity photocatalyst particles, a thin film can be readily formed on a surface of a substrate without impairing the outer appearance of the substrate to which the photocatalyst is applied. In addition, a step of incorporating photocatalyst particles into a substrate through a technique such as kneading can be facilitated. Through employment, as a raw material, of a sol comprising brookite-containing titanium oxide, two characteristics (i.e., dispersibility and adsorption performance) can be attained. Thus, a metal compound can be adsorbed on or incorporated into the surfaces of titanium oxide particles without performance of cumbersome steps such as heating, and adding an incorporation accelerator. In addition, the thus-produced titanium oxide particles have an excellent characteristic that the particles exhibit high dispersibility immediately after synthesis of the sol without performing special steps with respect to the produced photocatalyst. As a result, a coating film obtained from the sol is virtually colorless and transparent. Therefore, a film of a high-performance photocatalyst which absorbs visible light having a wavelength of 400 nm or longer can be formed on a surface of a substrate or incorporated into a substrate, through a simple technique and without impairing the outer appearance of the substrate.

By use of the brookite-containing titanium oxide comprising nitrogen atom, the photocatalyst, or the sol according to the second aspect of the present invention, photocatalytic performance of high catalytic response to visible light can be imparted, through a simple technique, to a variety of substrates such as metal, glass, plastics, paper, or wood. In particular, the thin film formed from the sol has high transparency, such high photocatalytic performance can be imparted to a variety of substrates or articles without impairing the outer appearance thereof. One characteristic feature of the brookite-containing titanium oxide sol of the second aspect of the present invention comprising nitrogen atoms resides in that titanium oxide small particles contained in the sol have crystallinity to some extent, despite the sol being stable. Thus, the sol of the second aspect of the present invention readily forms a photocatalytic thin film on a substrate with low heat resistance such as plastic or paper. The remarkable are characteristic features of the second aspect of the present invention include that the titanium oxide thin film produced from the titanium oxide sol of the second aspect of the present invention has a remarkably low impurity content, that very finely divided titanium oxide particles are dispersed in the film as virtually primary particles, and that the thin film has excellent photocatalytic performance by virtue of high crystallinity, and exhibits high response also to visible light. The thin film of the second aspect of the present invention has high film strength and high peel strength. Moreover, photocatalytic performance of the formed film can be enhanced by irradiating the film with UV light.

1. A sol comprising a precipitated component in an amount of less than 10 mass % based on the total solid content of the sol and comprising titanium oxide comprising a transition metal compound.

2. The sol according to claim 1, wherein the sol has a transmittance of 50% or more at a wavelength of 550 nm, as measured by use of a cell having an optical path length of 2 mm, when the sol contains water as a medium and has a solid content of 1 mass %.

3. The sol according to claim 1, wherein the transition metal compound does not contain particles having a particle size larger than 1 nm in an amount of 5 mass % or more.

4. The sol according to claim 1, which comprises the transition metal compound in an amount, as reduced to metal, of 0.01 to 1 mass % based on the total solid content.

5. The sol according to claim 1, wherein the transition metal compound comprises at least one selected from the group consisting of metal elements of Group 8 to 11 in the Periodic Table.

6. The sol according to claim 1, wherein the transition metal compound comprises at least one selected from the group consisting of metal elements of Group 10 in the Periodic Table.

7. The sol according to claim 1, wherein the transition metal compound comprises platinum as the transition metal.

8. The sol according to claim 1, wherein the transition metal compound is a chloride.

9. The sol according to claim 8, wherein the sol comprises a solid component which exhibits peaks at 72.5 eV and 75.5 eV (within a measurement error range of ±1.0 eV), as measured through X-ray photoelectron spectroscopy.

10. The sol according to claim 1, which comprises a photocatalyst exhibiting photocatalytic activity under visible light.

11. The sol according to claim 1, wherein the solid component of the sol exhibits a diffraction peak of lattice constant d (Å) of 2.90 (within a measurement error range of ±0.02 Å), as measured through powder X-ray diffraction employing Cu—Kα1 rays.

12. The sol according to any one of claims 1, wherein the solid component in the sol comprises a brookite titanium oxide.

13. The sol according to claim 12, wherein the solid component in the sol comprises a brookite titanium oxide in an amount of 10 mass % or more, as determined through Rietveld analysis.

14. The sol according to claim 12, wherein the solid component in the sol comprises a brookite titanium oxide in an amount of 30 mass % or more, as determined through Rietveld analysis.

15. The sol according to claim 1, wherein the solid component of the sol has a BET specific surface area of 20 to 400 m²/g.

16. A method for producing a sol, characterized in that the method comprises mixing an aqueous solution of a transition metal compound with a sol having a precipitated component in an amount less than 10% based on the total solid content in the sol and comprising titanium oxide.

17. A method for producing a sol, characterized in that the method comprises mixing a transition metal compound with a titanium compound and subjecting the mixture to hydrolysis.

18. A method for producing a sol, characterized in that the method comprises hydrolyzing a titanium compound in an aqueous solution comprising a transition metal compound.

19. A method for producing a sol according to claim 17, wherein the titanium compound is titanium tetrachloride or an aqueous solution of titanium tetrachloride.

20. The method for producing a sol as set forth in claim 16, wherein the transition metal compound comprises a chloride of the transition metal.

21. The method for producing a sol as set forth in claim 17, wherein hydrolysis is performed at 50° C. to a boiling temperature.

22. The method for producing a sol according to claim 21, wherein hydrolysis is performed at 75° C. to a boiling temperature.

23. The method for producing a sol as set forth in claim 17, wherein the titanium compound is added dropwise so as to mix with the transition metal compound upon hydrolysis.

24. A sol produced through the method for producing the sol as set forth in claim 16.

25. A powder produced by drying the sol as set forth in claim 1.

26. A powder produced by drying the sol as set forth in claim 1, through heating, reducing pressure, or freeze-drying, and by grinding or pulverizing the dried product.

27. An organic polymer comprising the sol as set forth in claim 1, or the solid component in the sol.

28. An organic polymer comprising, on a surface thereof, the sol as set forth in claim 1, or the solid component in the sol.

29. A coating composition comprising the sol as set forth in claim 1, and a binder component.

30. A thin film produced by applying to a substrate the sol as set forth in claim 1, and drying or hardening.

31. The thin film according to claim 30, which is hardened at 800° C. or lower.

32. The thin film according to claim 30, which is hardened at 150° C. or lower.

33. The thin film according to claim 30, which is hardened at 60° C. or lower.

34. The thin film according to claim 30, wherein the substrate comprises ceramics, metal, glass, plastics, paper, or wood.

35. An article having on a surface thereof or comprising a substance produced from the sol as set forth in claim 1.

36. An article according to claim 35, which is at least one member selected from the group consisting of building materials, fluorescent lamps, glass panes, machinery, vehicles, glass products, household electrical appliances, water purifying apparatuses, agricultural materials, electronic apparatus, tools, tableware, bath products, toiletry products, furniture, clothing, cloth products, fibers, leather products, paper products, sporting goods, beauty-related instruments, health improvement instruments, medical goods, futon, containers, eyeglasses, signboards, piping, wiring, brackets, sanitary materials, and automobile parts.
